(19) United States
(12) Patent Application Publication
(10) Pub. No.: US 2018/0259613 A1
(43) Pub. Date: Sep. 13, 2018

(54) OBJECT DETECTION DEVICE, OBJECT DETECTION SYSTEM AND OBJECT DETECTION METHOD

(71) Applicant: PANASONIC INTELLECTUAL PROPERTY MANAGEMENT CO., LTD., Osaka (JP)

(72) Inventors: Keiji HIRATA, Fukuoka (JP); Naoya TANAKA, Fukuoka (JP)

(73) Assignee: PANASONIC INTELLECTUAL PROPERTY MANAGEMENT CO., LTD., Osaka (JP)

(21) Appl. No.: 15/762,299

(22) PCT Filed: Aug. 24, 2016
(86) PCT No.: PCT/JP2016/003857

§ 371 Date: Mar. 22, 2018

(30) Foreign Application Priority Data
Sep. 30, 2015 (JP) 2015-195231

(51) Int. Cl. G01S 3/808; G01S 5/20; G01S 3/802; H04N 5/232; H04R 1/40

(52) U.S. Cl. CPC G01S 3/8083; G01S 5/20; G01S 3/8022; H04N 5/2252; H04N 5/23293; H04R 1/406; H04N 5/23296

(57) ABSTRACT

An object detection device includes a microphone array that includes a plurality of non-directional microphones, and a processor that processes first sound data obtained by collecting sounds by the microphone array. The processor generates a plurality of items of second sound data having directivity in an arbitrary direction by sequentially changing a directivity direction based on the first sound data, and analyzes a sound pressure level and a frequency component of the second sound data, and determines that an object exists in a first direction in a case where a sound pressure level of a specific frequency, which is included in the frequency component of the second sound data having directivity in the first direction of the arbitrary direction, is equal to or larger than a first prescribed value.

### TECHNICAL FIELD

The present disclosure relates to an object detection device, an object detection system, and an object detection method, which detect an object.

### BACKGROUND ART

A flying object monitoring device has been known (for example, refer to PTL 1) which is capable of detecting existence of an object and detecting a flying direction of the object using a sound detector which detects sounds in respective directions.

An object of the present disclosure is to improve object detection accuracy.

### CITATION LIST

### Patent Literature

PTL 1: Japanese Patent Unexamined Publication No. 2006-168421

### SUMMARY OF THE INVENTION

An object detection device according to the present disclosure includes a microphone array that includes a plurality of non-directional microphones, and a processor that processes first sound data obtained by collecting sounds collected by the microphone array. The processor generates a plurality of items of second sound data having directivity in an arbitrary direction by sequentially changing a directivity direction based on the first sound data, and analyzes a sound pressure level and a frequency component of the second sound data. The processor determines that an object exists in a first direction in a case where a sound pressure level of a specific frequency, which is included in the frequency component of the second sound data having directivity in the first direction of the arbitrary direction, is equal to or larger than a first prescribed value.

According to the present disclosure, it is possible to improve object detection accuracy.

### BRIEF DESCRIPTION OF DRAWINGS

FIG. 1 is a schematic diagram illustrating an example of a schematic configuration of an object detection system according to a first embodiment.

FIG. 2 is a block diagram illustrating the example of the configuration of the object detection system according to a first embodiment.

FIG. 3 is a timing chart illustrating an example of a sound pattern of a moving body recorded in a memory.

FIG. 4 is a timing chart illustrating an example of frequency change in sound data acquired as a result of a frequency analysis process.

FIG. 5 is a schematic diagram illustrating an example of an aspect in which a directivity range is scanned in the monitoring area and a moving body is detected.

FIG. 6 is a schematic diagram illustrating an example of an aspect in which the moving body is detected by scanning a directivity direction in a first directivity range where the moving body is detected.

FIG. 7 is a flowchart illustrating a first operation example of a procedure of a process of detecting the moving body according to the first embodiment.

FIG. 8 is a flowchart illustrating a second operation example of the procedure of the process of detecting the moving body according to the first embodiment.

FIG. 9 is a schematic diagram illustrating an example of an omnidirectional image which is imaged by an omnidirectional camera according to the first embodiment.

FIG. 10 is a block diagram illustrating a configuration of an object detection system according to a modified example of the first embodiment.

FIG. 11 is a flowchart illustrating a procedure of the process of detecting the moving body according to the modified example of the first embodiment.

FIG. 12 is a schematic diagram illustrating an example of a schematic configuration of an object detection system according to a second embodiment.

FIG. 13 is a block diagram illustrating an example of the configuration of the object detection system according to the second embodiment.

FIG. 14 is a timing chart illustrating an example of a distance measurement method.

FIG. 15 is a flowchart illustrating an operation example of the object detection system according to the second embodiment.

FIG. 16 is a schematic diagram illustrating an example of an omnidirectional image which is imaged by an omnidirectional camera according to the second embodiment.

FIG. 17 is a schematic diagram illustrating an example of a schematic configuration of an object detection system according to a third embodiment.

FIG. 18 is a block diagram illustrating the example of the configuration of the object detection system according to the third embodiment.

FIG. 19 is a flowchart illustrating an operation example of the object detection system according to the third embodiment.

FIG. 20 is a schematic diagram illustrating an example of an image acquired by a PTZ camera according to the third embodiment.

FIG. 21 is a schematic diagram illustrating an example of a schematic configuration of an object detection system according to a fourth embodiment.

FIG. 22 is a block diagram illustrating the example of the configuration of the object detection system according to the fourth embodiment.

FIG. 23 is a flowchart illustrating an operation example of the object detection system according to the fourth embodiment.

FIG. 24 is a schematic diagram illustrating an example of a schematic configuration of an object detection system according to a fifth embodiment.

FIG. 25 is a block diagram illustrating the example of the configuration of the object detection system according to the fifth embodiment.

FIG. 26 is a schematic diagram illustrating an example of a method for measuring a distance up to a moving body using two sound source detection devices.

FIG. 27 is a flowchart illustrating an operation example of the object detection system according to the fifth embodiment.

FIG. 28 is a diagram illustrating an example of an appearance of a sound source detection unit according to a sixth embodiment.

### DESCRIPTION OF EMBODIMENTS

Hereinafter, embodiments will be described in detail with reference to the appropriate accompanying drawings. However, there is a case where unnecessarily detailed description is omitted. For example, there is a case where detailed description of already well-known items and duplicated description with respect to substantially the same configurations are omitted. The reason for this is to avoid the description below being unnecessarily redundant and to make those skilled in the art easily understand. Also, the accompanying drawings and the description below are provided such that those skilled in the art sufficiently understand the present disclosure, and it is not intended to limit subjects disclosed in claims by the accompanying drawings and the description below.

In a flying object monitoring device, in which a directivity microphone is used as a sound detector, sounds in the respective directions are detected in such a way that one directivity microphone is turned or a plurality of directivity microphones are installed forward the respective directions which cover monitoring areas.

In a case where one directivity microphone is turned, time for rotation is necessary and it is difficult to simultaneously detect sounds in the respective directions. Therefore, in a case where an object moves while the directivity microphone turns, object detection accuracy is lowered.

In a case where the plurality of directivity microphones are installed forward the respective directions which cover the monitoring areas, there is a case where an area (for example, an area which is difficult to be covered by adjacent directivity microphones), in which it is difficult to perform object detection, is generated due to the directivity microphones. In a case where the object is positioned in the area, the object detection accuracy is lowered.

Hereinafter, an object detection device, an object detection system, and an object detection method, in which it is possible to improve the object detection accuracy, will be described.

### First Embodiment

[Configuration]

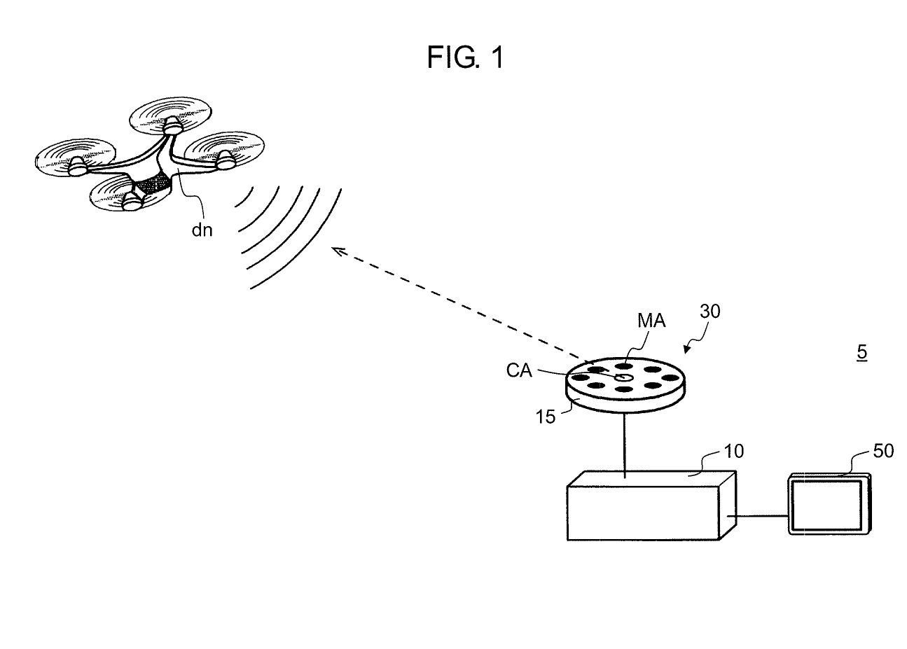

FIG. 1 is a schematic diagram illustrating a schematic configuration of object detection system 5 according to a first embodiment. Object detection system 5 detects moving body dn. Moving body dn is an example of a detection target (target). Moving body dn includes, for example, a drone, a radio-controlled helicopter, and a reconnaissance drone.

In the embodiment, a multicopter-type drone, on which a plurality of rotors (rotor blades) are placed, is illustrated as moving body dn. In the multicopter-type drone, generally, in a case where the number of rotary wings is two, higher harmonic waves in a frequency which is two times of a specific frequency and, furthermore, higher harmonic waves in a frequency which is multiplication thereof are generated. Similarly, in a case where the number of rotary wings is three, higher harmonic waves in a frequency which is three times of the specific frequency and, furthermore, higher harmonic waves in a frequency which is multiplication thereof are generated. In a case where the number of rotary wings is four, higher harmonic waves are generated similarly.

Object detection system 5 includes sound source detection device 30, control box 10, and monitor 50. Sound source detection device 30 includes microphone array MA and omnidirectional camera CA. Sound source detection device 30 collects omnidirectional sounds in a sound collection space (a sound collection area), in which the device is installed, using microphone array MA.

Sound source detection device 30 includes housing 15, which has an opening at a center, and microphone array MA. Sounds widely include, for example, mechanical sounds, voice, and other sounds.

Microphone array MA includes a plurality of non-directional microphones M1 to M8 which are disposed at predetermined intervals (for example, average intervals) in a concentric shape along a circumferential direction around the opening of housing 15. For example, Electret Condenser Microphone (ECM) is used as the microphone. Microphone array MA transmits sound data of the collected sounds to a configuration unit at a rear stage of microphone array MA. Also, the disposition of the above-described respective microphones M1 to M8 is an example, and another disposition and a form may be provided.

In addition, microphone array MA includes a plurality of microphones M1 to Mn (for example, n=8) and a plurality of amplifiers (amp) which respectively amplify output signals of the plurality of microphones M1 to Mn. Analog signals, which are output from the respective amplifiers, are respectively converted into digital signals by A/D converter 31 which will be described later.

Also, the number of microphones in the omnidirectional microphones is not limited to eight, and may be another number (for example, 16 or 32).

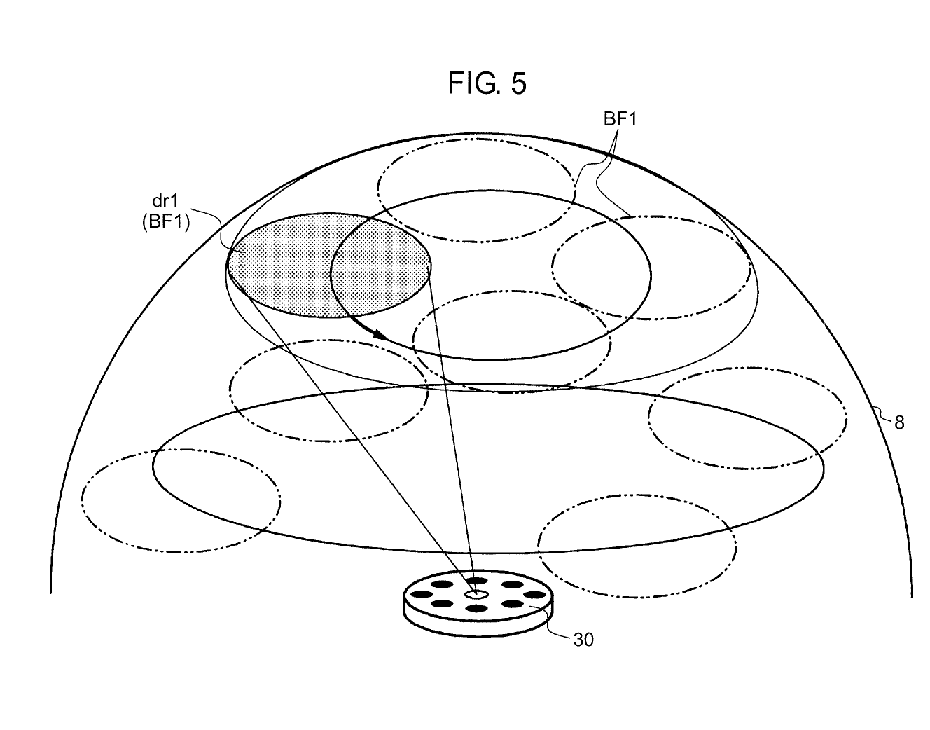

Omnidirectional camera CA is accommodated inside the opening of housing 15 of microphone array MA. Omnidirectional camera CA is a camera in which a fisheye lens that is capable of imaging an omnidirectional image is placed. Omnidirectional camera CA functions as, for example, a monitoring camera which is capable of imaging an imaging space (imaging area) in which sound source detection device 30 is installed. That is, omnidirectional camera CA has angles of 180° in a vertical direction and 360° in a horizontal direction, and images, for example, monitoring area 8 (refer to FIG. 5), which is a half-celestial sphere, as the imaging area.

In sound source detection device 30, omnidirectional camera CA is embedded in an inner side of the opening of housing 15, and thus omnidirectional camera CA and microphone array MA are disposed on the same axis. As above, an optical axis of omnidirectional camera CA coincides with a central axis of microphone array MA, with the result that the imaging area is substantially the same as the sound collection area in an axis-circumferential direction (horizontal direction), and thus it is possible to express an image position and a sound collection position using the same coordinate system.

Also, sound source detection device 30 is attached such that, for example, an upper part of the vertical direction becomes a sound collection surface and an imaging surface in order to detect moving body dn which flies from the sky.

Sound source detection device 30 forms (performs beam forming) directivity in an arbitrary direction with respect to omnidirectional sounds collected by microphone array MA, and emphasizes the sounds in the directivity direction. Also, a technology related to a sound data directivity control process in order to perform beam forming on the sounds collected by microphone array MA is a well-known technology as disclosed in, for example, PTL 1 and PTL 2 (PTL 1: Japanese Patent Unexamined Publication No. 2014-143678, PTL 2: Japanese Patent Unexamined Publication No. 2015-029241).

Sound source detection device 30 processes an imaging signal in association with imaging, and generates an omnidirectional image using omnidirectional camera CA.

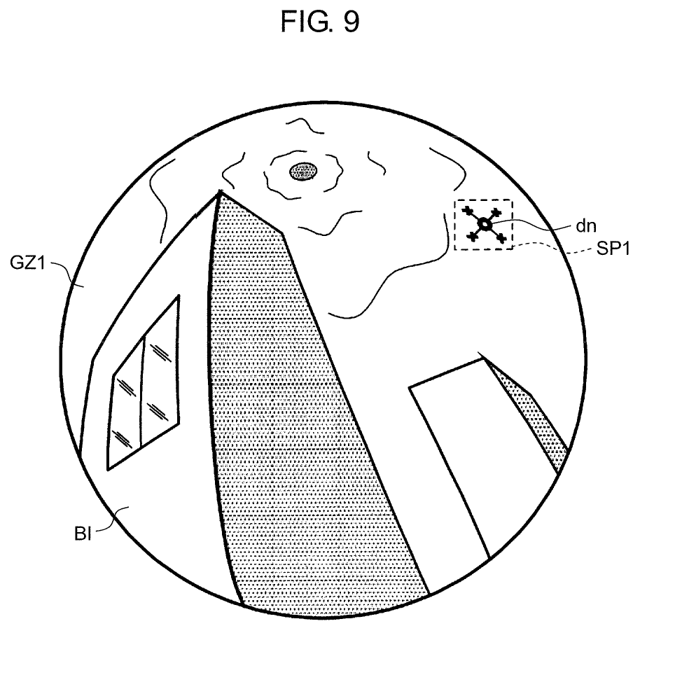

Control box 10 outputs predetermined information to, for example, monitor 50 based on an image based on sounds which are collected by sound source detection device 30 and an image based on an image which is imaged by omnidirectional camera CA. For example, control box 10 displays the omnidirectional image and sound source direction image sp1 (refer to FIG. 9) of detected moving body dn on monitor 50. Control box 10 includes, for example, a Personal Computer (PC) and a server.

Monitor 50 displays the omnidirectional image which is imaged by omnidirectional camera CA. In addition, monitor 50 generates and displays a composite image in which sound source direction image sp1 is superimposed on the omnidirectional image. Also, monitor 50 may be formed as a device integrated with control box 10.

In FIG. 1, sound source detection device 30, omnidirectional camera CA, and control box 10 are respectively connected to control box 10 without going through a network, and data is transmitted. That is, the respective devices include communication interfaces. Also, the respective devices may be connected through the network such that it is possible to perform data communication with each other. The network may be a wired network (for example, Intranet, the Internet, a wired Local Area Network (LAN)) or may be a wireless network (for example, a wireless LAN).

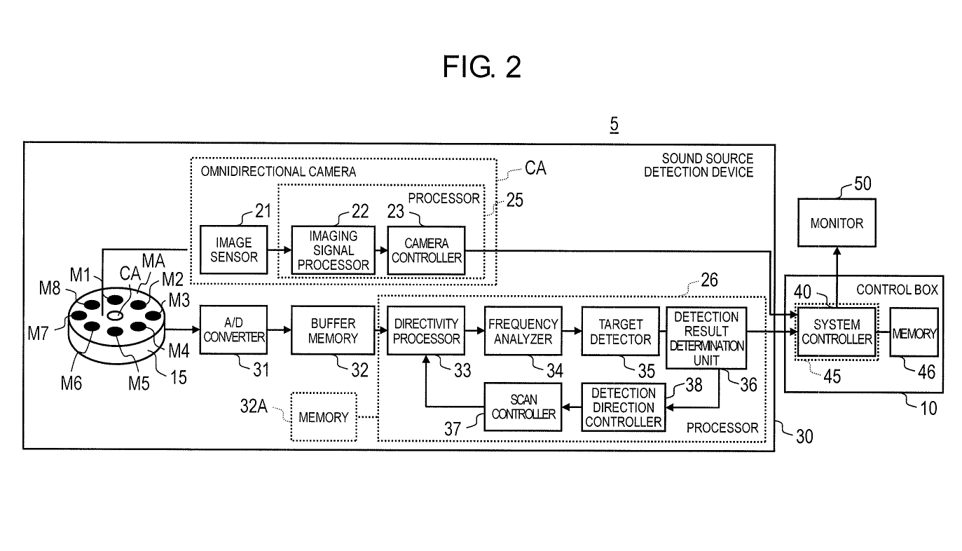

FIG. 2 is a block diagram illustrating a configuration of object detection system 5.

Sound source detection device 30 includes image sensor 21, imaging signal processor 22, and camera controller 23. Sound source detection device 30 includes microphone array MA, A/D converter 31, buffer memory 32, directivity processor 33, frequency analyzer 34, target detector 35, detection result determination unit 36, scan controller 37, and detection direction controller 38.

Image sensor 21, imaging signal processor 22, and camera controller 23 operate as omnidirectional camera CA, and belong to a system (image processing system) which processes an image signal. A/D converter 31, buffer memory 32, directivity processor 33, frequency analyzer 34, target detector 35, detection result determination unit 36, scan controller 37, and detection direction controller 38 belong to a system (sound processing system) which processes sound signals.

Also, in a case where processor 25 executes a program maintained in memory 32A, respective functions of imaging signal processor 22 and camera controller 23 are realized. In a case where processor 26 executes a program maintained in memory 32A, respective functions of directivity processor 33, frequency analyzer 34, target detector 35, detection result determination unit 36, scan controller 37, and detection direction controller 38 are realized.

Image sensor 21 is a solid state imaging device such as a Charge Coupled Device (CCD) or a Complementary Metal Oxide Semiconductor (CMOS). Image sensor 21 images an image (omnidirectional image) which is formed on an imaging surface of the fisheye lens.

Imaging signal processor 22 converts a signal of an image, which is imaged by image sensor 21, into an electric signal, and performs various image processes. Camera controller 23 controls respective units of omnidirectional camera CA, and supplies a timing signal to, for example, image sensor 21.

A/D converter 31 performs analog digital conversion (A/D conversion) on the sound signals respectively output from respective microphones M1 to M8 of microphone array MA, and generates and outputs the sound data in digital values. A/D converter 31 is provided as many as the number of microphones.

Buffer memory 32 includes a Random Access Memory (RAM) or the like. Buffer memory 32 temporarily stores the sound data obtained by collecting sounds by respective microphones M1 to M8 of microphone array MA and converted into the digital values by A/D converter 31. Buffer memory 32 is provided as many as the number of microphones.

Memory 32A is connected to processor 26 and includes a Read Only Memory (ROM) and a RAM. Memory 32A maintains, for example, various data, setting information, and a program. Memory 32A includes a pattern memory in which a unique sound pattern is registered in individual moving body dn.

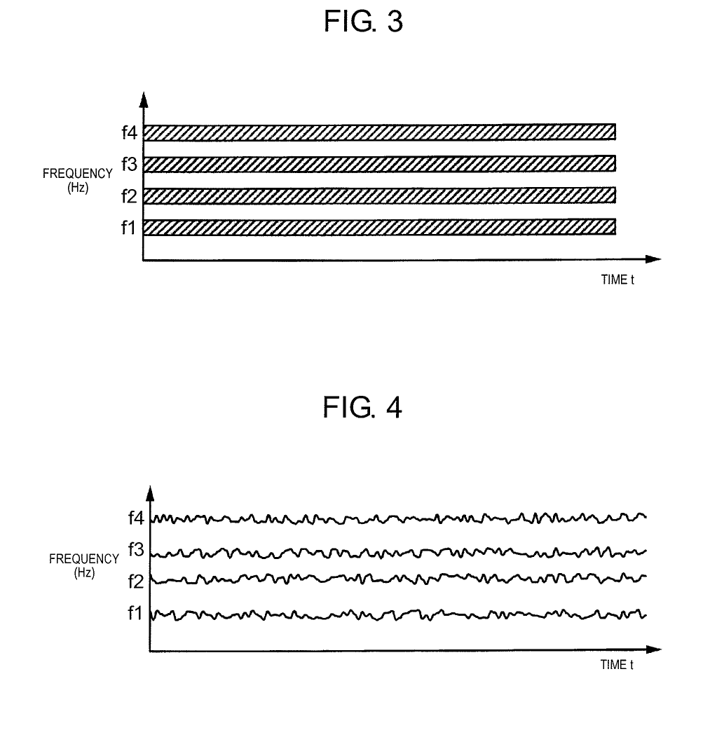

FIG. 3 is a timing chart illustrating an example of a sound pattern of moving body dn registered in memory 32A.

The sound pattern illustrated in FIG. 3 is a combination of frequency patterns, and includes sounds of four frequencies f1, f2, f3, and f4 which are generated through rotation or the like of four rotors placed in multicopter-type moving body dn. The respective frequencies are, for example, frequencies of sounds generated in association with rotation of a plurality of pieces of wings supported by axis by the respective rotors.

In FIG. 3, frequency areas indicated with hatched lines are areas in which a sound pressure is high. Also, the sound pattern may include other sound information in addition to the number of sounds and the sound pressures of the plurality of frequencies. For example, a sound pressure ratio, which indicates a ratio of the sound pressures of the respective frequencies, or the like may be included. Here, as an example, detection of moving body do is determined according to whether or not the sound pressures of the respective frequencies included in the sound pattern are higher than a threshold.

Directivity processor 33 performs the above-described directivity forming process (beam forming) using the sound data obtained by collecting sounds by non-directional microphones M1 to M8, and performs a sound data extraction process in which an arbitrary direction is used as the directivity direction. In addition, directivity processor 33 performs the sound data extraction process in which a range of the arbitrary direction is set to a directivity range. The directivity range is a range which includes a plurality of adjacent directivity directions and which intends to include an area of the directivity direction to some extent, compared to the directivity direction.

Frequency analyzer 34 performs a frequency analysis process on the sound data, on which the extraction process is performed in the directivity range or in the directivity direction, by directivity processor 33. In the frequency analysis process, frequencies and the sound pressures thereof included in the sound data in the directivity direction or in the directivity range are detected.

FIG. 4 is a timing chart illustrating frequency change in the sound data acquired as a result of the frequency analysis process.

In FIG. 4, four frequencies f1, f2, f3, and f4 and sound pressures of the respective frequencies are acquired as the sound data. In the drawing, variations in the respective frequencies, which irregularly change, occur due to rotations of the rotors (rotary wings) which change slightly in a case where, for example, posture control is performed on moving body dn.

Target detector 35 performs a process of detecting moving body dn. In the process of detecting moving body dn, target detector 35 compares the sound pattern (refer to FIG. 4) (frequencies f1 to f4), which is acquired as the result of the frequency analysis process, with the sound pattern (refer to FIG. 3) (frequencies f1 to f4) which is registered in the pattern memory of memory 32A in advance. Target detector 35 determines whether or not both the sound patterns approximate to each other.

For example, whether or not both the patterns approximate to each other is determined as below. In a case where the sound pressures of at least two frequencies, which are included in the sound data, among four frequencies f1, f2, f3, and f4 are larger than the threshold, respectively, it is assumed that the sound patterns approximate to each other, and the target detector 35 detects moving body dn. Also, moving body dn may be detected in a case where another condition is satisfied.

In a case where detection result determination unit 36 determines that moving body dn does not exist, detection result determination unit 36 instructs detection direction controller 38 to detect moving body dn in a subsequent directivity range without changing a size of the directivity range.

In a case where detection result determination unit 36 determines that moving body dn exists as a result of a scan of the directivity range, detection result determination unit 36 instructs detection direction controller 38 to reduce a beam forming range for object detection. That is, detection result determination unit 36 instructs to change the beam forming range from the directivity range to the directivity direction. Also, the directivity range may be provided in a plurality of stages, and the beam forming range may be reduced in stages whenever moving body dn is detected.

In a case where detection result determination unit 36 determines that moving body dn exists as the result of the scan in the directivity direction, detection result determination unit 36 notifies system controller 40 of a detection result of moving body dn. Also, the detection result includes information of detected moving body dn. The information of moving body dn includes, for example, identification information of moving body dn, and positional information (direction information) of moving body dn in the sound collection space.

In a case where the beam forming range is variable, sound source detection device 30 is capable of improving efficiency of a substance detection operation. Information of the beam forming range and information of a method for reducing the beam forming range are maintained in, for example, memory 32A.

Detection direction controller 38 controls a direction in which moving body dn is detected in the sound collection space based on the instruction from detection result determination unit 36. For example, detection direction controller 38 sets the arbitrary direction and the range as a detection direction and a detection range in the whole sound collection space.

Scan controller 37 instructs directivity processor 33 to perform beam forming on the detection range and the detection direction, which are set by detection direction controller 38, as the directivity range and the directivity direction.

Directivity processor 33 performs beam forming with respect to the directivity range and the directivity direction (for example, a subsequent directivity range in the scan) instructed from scan controller 37.

Control box 10 includes system controller 40. Also, in a case where processor 45 included in control box 10 executes a program maintained in memory 46, a function of system controller 40 is realized.

System controller 40 controls a cooperative operation of an image processing system and a sound processing system of sound source detection device 30 and monitor 50. For example, system controller 40 superimposes an image, which indicates a position of moving body dn, on an image, which is acquired by omnidirectional camera CA, based on information of moving body dn from detection result determination unit 36, and outputs a composite image to monitor 50.

[Operation]

Subsequently, an operation of detecting moving body dn, which is performed by object detection system 5, will be described.

Here, a first operation and a second operation will be described. The first operation is an operation of dividing the beam forming range by sound source detection device 30 into two stages and scanning the sound collection area in a case where existence of moving body dn is detected based on sound pressures of the sounds emitted from moving body dn. That is, after scan is performed in the directivity range, scan is performed in the directivity direction. The second operation is an operation of uniformly maintaining the beam forming range by sound source detection device 30 and scanning the sound collection area. That is, scan is performed in the directivity direction from the beginning. Also, although an example in which the sound collection area is the same as monitoring area 8 is illustrated, the sound collection area may not be the same as monitoring area 8.

### First Operation Example

In a first operation example, sound source detection device 30 detects moving body dn by taking directivity range BF1 in consideration. That is, directivity processor 33 performs beam forming with respect to the sound data, which is obtained by collecting sounds by microphone array MA in monitoring area 8, toward directivity range BF1. In addition, beam forming is performed with respect to the sound data, which is obtained by collecting sounds by microphone array MA, toward directivity direction BF2 in first directivity range dr1 where moving body dn exists.

FIG. 5 is a schematic diagram illustrating an aspect in which monitoring area 8 is scanned and moving body dn is detected in arbitrary directivity range BF1.

In FIG. 5, processor 26 sequentially scans arbitrary directivity range BF1 among a plurality of directivity ranges BF1 in monitoring area 8. For example, in a case where moving body dn is detected in first directivity range dr1 of monitoring area 8, processor 26 determines that moving body dn exists in detected first directivity range dr1. Furthermore, processor 26 sequentially scans arbitrary directivity direction BF2, which is narrower than first directivity range dr1, in first directivity range dr1.

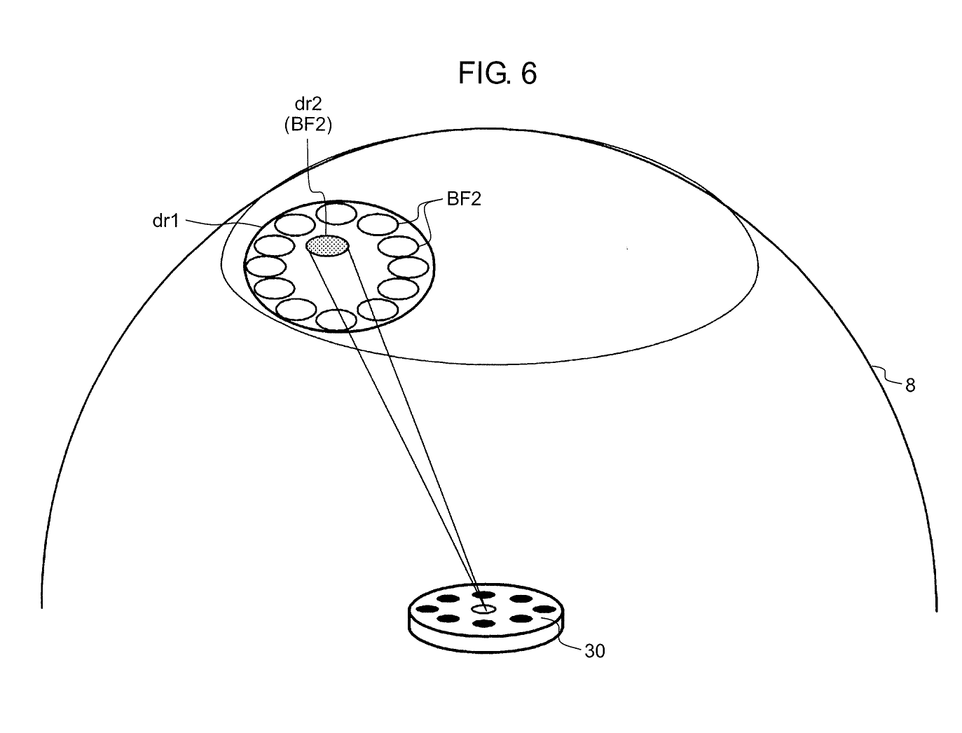

FIG. 6 is a schematic diagram illustrating an aspect in which moving body dn is detected in arbitrary directivity direction BF2 by scanning first directivity range dr.

In FIG. 6, processor 26 sequentially scans arbitrary directivity direction BF2 among a plurality of directivity directions BF2 in first directivity range dr1 in which moving body dn is detected. For example, in a case where target detector 35 detects that a sound pressure of the specific frequency is equal to or higher than prescribed value th1 in first directivity direction dr2 in first directivity range dr1, target detector 35 determines that moving body dn exists in first directivity direction dr2.

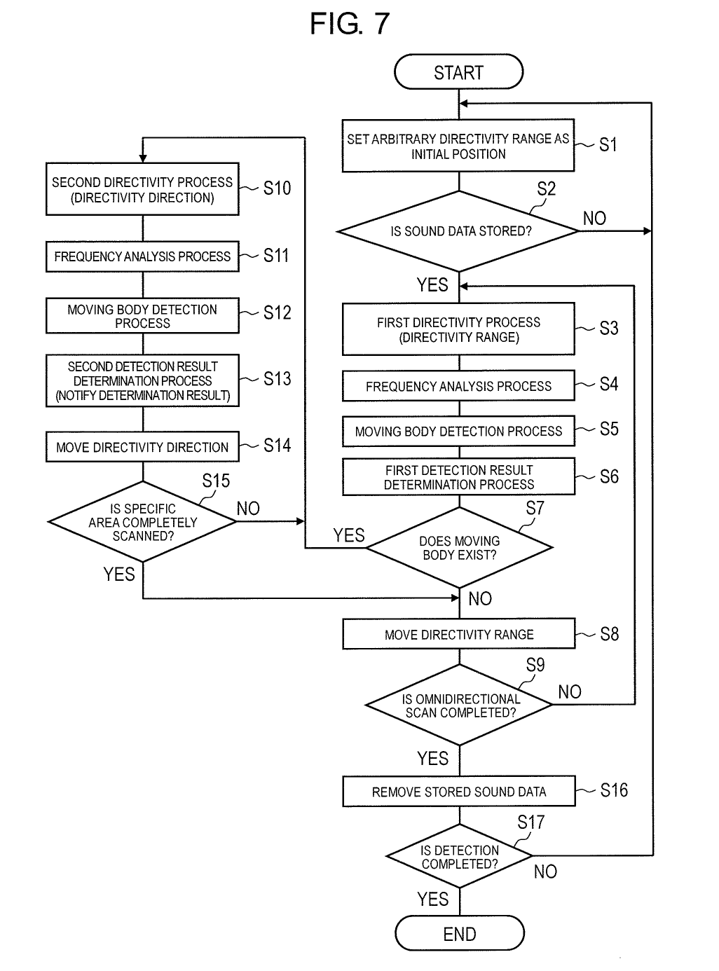

FIG. 7 is a flowchart illustrating the first operation example of a procedure of the process of detecting moving body dn by sound source detection device 30.

First, directivity processor 33 sets directivity range BF1 as an initial position (S1). In the initial position, arbitrary directivity range BF1 is set as a directivity range of a scan target. In addition, directivity processor 33 may set directivity range BF1 to an arbitrary size.

Directivity processor 33 determines whether or not the sound data, which is obtained by collecting sounds by microphone array MA and is converted into the digital values by A/D converter 31, is temporarily stored (buffered) in buffer memory 32 (S2). In a case where the sound data is not stored in buffer memory 32, directivity processor 33 returns to the process in S1.

In a case where the sound data is stored in buffer memory 32, directivity processor 33 performs beam forming in arbitrary directivity range BF1 (the first is an initially-set directivity range) with respect to monitoring area 8, and extracts sound data of directivity range BF1 (S3).

Frequency analyzer 34 detects a frequency of sound data, on which the extraction process is performed, in directivity range BF1 and the sound pressure thereof (a frequency analysis process) (S4).

Target detector 35 compares the sound pattern, which is registered in the pattern memory of memory 32A, with a sound pattern acquired as the result of the frequency analysis process (the process of detecting moving body dn) (S5).

Detection result determination unit 36 notifies system controller 40 of a result of the comparison and notifies detection direction controller 38 of transition of the detection direction (a process of determining a detection result) (S6).

For example, target detector 35 compares the sound pattern, which is acquired as the result of the frequency analysis process, with four frequencies f1, f2, f3, and f4 which are registered in the pattern memory of memory 32A. As a result of the comparison, in a case where at least two frequencies, which are the same, exist in both the sound patterns and the sound pressures of the frequencies are equal to or larger than the prescribed value th1, target detector 35 determines that both the sound patterns approximate to each other and moving body dn exists.

Also, here, although a case is assumed in which at least two frequencies coincide with each other, target detector 35 may determine that the sound patterns approximate to each other in a case where one frequency coincides and the sound pressure of the frequency is equal to or larger than prescribed value th1.

In addition, target detector 35 may determine whether or not the sound patterns approximate to each other by setting a permissible frequency error with respect to each of the frequencies and assuming that frequencies in an error range are the same.

In addition, target detector 35 may perform determination by adding a fact that sound pressure ratios of sounds corresponding to the respective frequencies substantially coincide with each other to a determination condition in addition to the comparison performed on the frequencies and the sound pressures. In this case, since the determination condition becomes strict, it is easy for sound source detection device 30 to specify detected moving body dn as a previously registered target (moving body dn), and thus it is possible to improve detection accuracy of moving body dn.

Detection result determination unit 36 determines whether or not moving body dn exists as a result of S6 (S7). Also, S6 and S7 may be included in one process.

In a case where moving body dn does not exist, scan controller 37 causes directivity range BF1 of the scan target in monitoring area 8 to move to a subsequent range (S8).

Also, an order, in which directivity range BF1 is sequentially moved in monitoring area 8, may be a sequence of a spiral shape (helical shape) so as to face, for example, from an external circumference to an internal circumference in monitoring area 8 or to face from the internal circumference to the external circumference.

As above, in a case where sound source detection device 30 scans directivity range BF1, which has an area to some extent in the directivity direction, in monitoring area 8, it is possible to reduce time required to determine whether or not moving body dn exists in monitoring area 8.

In addition, the scan is not performed continuously like one-stroke sketch, and positions may be set in monitoring area 8 in advance and directivity range BF1 may move to the respective positions in an arbitrary order. Therefore, sound source detection device 30 is capable of starting the detection process from, for example, a position into which moving body dn easily invades, and thus it is possible to make efficiency of the detection process.

Scan controller 37 determines whether or not omnidirectional scan is completed in monitoring area 8 (S9). In a case where the omnidirectional scan is not completed, directivity processor 33 returns to the process in S3, and performs the same operations. That is, directivity processor 33 performs beam forming in the directivity range at the position moved in S8, and performs the sound data extraction process in the directivity range.

In contrast, in a case where it is determined that moving body dn exists in S7, directivity processor 33 performs beam forming in arbitrary directivity direction BF2 (the first is the directivity direction of initial setting) in first directivity range dr1 in which moving body dn is detected (refer to FIG. 5), and performs the sound data extraction process in directivity direction BF2 (S10).

Frequency analyzer 34 detects the frequency of the sound data, on which the extraction process is performed in the directivity direction BF2, and the sound pressure thereof (frequency analysis process) (S11).

Target detector 35 compares the sound pattern, which is registered in the pattern memory of memory 32A, with the sound pattern which is acquired as the result of the frequency analysis process. In a case where it is determined that the sound patterns approximate to each other as a result of the comparison, target detector 35 determines that moving body dn exists. In a case where it is determined that the sound patterns do not approximate to each other, it is determined that moving body dn does not exist (the process of detecting moving body dn) (S12).

For example, in a case where there are at least two frequencies, which are the same, in the sound pattern, which is acquired as the result of the frequency analysis process, and four frequencies f1, f2, f3, and f4, which are registered in the pattern memory of memory 32A, and the sound pressures of the frequencies are equal to or larger than prescribed value th2, target detector 35 determines that both the sound patterns approximate to each other and moving body dn exists. Also, prescribed value th2 is equal to or larger than, for example, prescribed value th1.

As above, in a case where the sound pressure of the sound data, which includes a frequency that is the same as the frequency registered in the sound pattern, is equal to or larger than prescribed value th2, detection result determination unit 36 determines that moving body dn exists. The other determination method is the same as in S5.

Detection result determination unit 36 notifies system controller 40 of the result of the comparison performed by target detector 35, and notifies detection direction controller 38 of transition of the detection direction (detection result determination process) (S13).

In a case where moving body dn exists in S13, detection result determination unit 36 provides a notification that moving body dn exists (a detection result of moving body dn) to system controller 40. Also, a notification of the detection result of moving body dn may be collectively performed after scan is completed in the directivity direction in one directivity range BF1 or after the omnidirectional scan is completed instead of timing at which an one directivity direction detection process ends.

Scan controller 37 causes arbitrary directivity direction BF2 to move in a direction of a subsequent scan target in first directivity range dr1 (S14).

Detection result determination unit 36 determines whether or not to complete the scan in first directivity range dr1 (S15). In a case where the scan in first directivity range dr1 is not completed, directivity processor 33 returns to the process in S10.

In a case where the scan in first directivity range dr1 is completed in S15, directivity processor 33 proceeds to the process in S8 and repeats the above-described processes until the omnidirectional scan is completed in monitoring area 8 in S9. Therefore, even though one moving body dn is detected, sound source detection device 30 continues detection of another moving body dn which might exist, and thus it is possible to detect a plurality of moving bodies dn.

In a case where the omnidirectional scan is completed in S9, directivity processor 33 removes the sound data which is temporarily stored in buffer memory 32 and which is obtained by collecting sounds by microphone array MA (S16).

After the sound data is removed, processor 26 determines whether or not to end the process of detecting moving body dn (S17). The process of detecting moving body dn ends according to a prescribed event. For example, processor 26 may maintain the number of times, in which moving body dn is not detected in S6 and S13, in memory 32A, and may end the process of detecting moving body dn of FIG. 7 in a case where the number of times is equal to or larger than a predetermined number of times. In addition, processor 26 may end the process of detecting moving body dn of FIG. 7 based on time-up by a timer and a user operation with respect to a User Interface (UI) included in control box 10. In addition, the process of detecting moving body dn may end in a case where power of sound source detection device 30 is turned off.

Also, in S4 and S11, frequency analyzer 34 analyzes the frequencies and measures the sound pressures of the frequencies. In a case where the sound pressure level measured by frequency analyzer 34 becomes gradually large as time elapses, detection result determination unit 36 may determine that moving body dn is approaching sound source detection device 30.

For example, in a case where a sound pressure level of a prescribed frequency measured at time t11 is smaller than a sound pressure level of the same frequency measured at time t12 which is later than time t11, the sound pressure becomes large as time elapses, and thus it may be determined that moving body dn is approaching. In addition, it may be determined that moving body dn is approaching by measuring the sound pressure level more than three times based on transition of statistics (a variation value, an average value, a maximum value, a minimum value, and the like).

In addition, in a case where the measured sound pressure level is equal to or larger than prescribed value th3 which is a warning level, detection result determination unit 36 may determine that moving body dn invades a warning area.

Also, prescribed value th3 is equal to or larger than, for example, prescribed value th2. The warning area is, for example, an area which is the same as monitoring area 8 or an area which is included in monitoring area 8 and is narrower than monitoring area 8. The warning area is, for example, an area in which invasion performed by moving body dn is restricted. In addition, determination of the approach and the invasion performed by moving body dn may be performed by system controller 40.

### Second Operation Example

In a second operation example, sound source detection device 30 sequentially scans directivity direction BF2 and detects moving body dn in monitoring area 8 without taking directivity range BF1 into consideration.

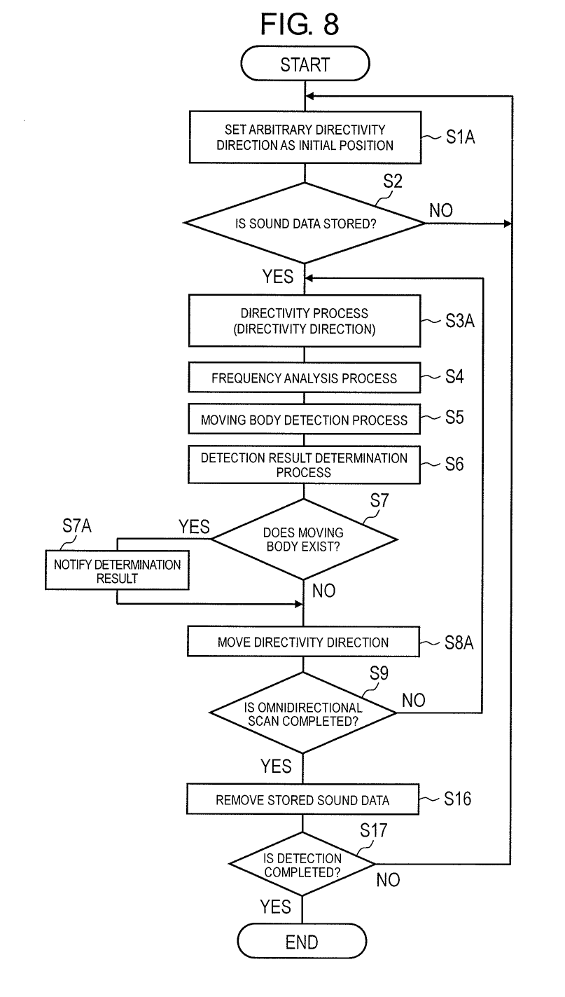

FIG. 8 is a flowchart illustrating the second operation example of the procedure of the process of detecting moving body dn by sound source detection device 30. The same step numbers are attached to the same processes as in the first operation example illustrated in FIG. 7, and description thereof will be omitted.

First, directivity processor 33 sets directivity direction BF2 as an initial position (S1A). In the initial position, arbitrary directivity direction BF2 is set as a directivity direction of a scan target.

In a case where the sound data obtained by collecting sounds by microphone array MA is temporarily stored in buffer memory 32 in S2, directivity processor 33 performs beam forming in arbitrary directivity direction BF2 (the first is a directivity direction of the initial setting) of monitoring area 8, and performs the sound data extraction process in directivity direction BF2 (S3A).

In a case where moving body dn does not exist according to a result of determination of existence of moving body dn performed by target detector 35 and detection result determination unit 36 in S7, scan controller 37 causes directivity direction BF2 of the scan target in monitoring area 8 to move in a subsequent direction (S8A).

In contrast, in a case where moving body dn exists in S7, detection result determination unit 36 provides the notification that moving body dn exists (the detection result of moving body dn) to system controller 40 (S7A). Thereafter, the process proceeds to S8. Also, the notification of the detection result of moving body dn may be collectively provided after the omnidirectional scan is completed instead of the timing at which an one directivity direction detection process ends.

As above, in the second operation example, sound source detection device 30 performs the scan using directivity range BF1 and the scan using directivity direction BF2 without switching, and thus it is possible to simplify the process.

FIG. 9 is a schematic diagram illustrating omnidirectional image GZ1 which is imaged by omnidirectional camera CA.

In FIG. 9, omnidirectional image GZ1 includes moving body dn which flies from a valley of building B1. Monitor 50 is displayed such that, for example, sound source direction image sp1, in which a mechanical sound of moving body dn is used as a sound source, is superimposed on (overlaid) omnidirectional image GZ1. Here, sound source direction image sp1 is displayed as a rectangular dotted-line frame. Also, monitor 50 may display the positional information by displaying positional coordinates of moving body dn on omnidirectional image GZ1 instead of displaying sound source direction image sp1. A process of generating and superimposing sound source direction image sp1 is performed by, for example, system controller 40.

[Effect]

As above, object detection system 5 according to the first embodiment includes sound source detection device 30. Sound source detection device 30 includes microphone array MA (microphone array) which has the plurality of non-directional microphones M1 to M8, and processor 26 which processes the first sound data obtained by collecting sounds by microphone array MA. Processor 26 sequentially changes directivity direction BF2 (directivity direction) based on the first sound data, generates a plurality of items of second sound data having directivity in arbitrary directivity direction BF2, and analyzes a sound pressure level of the second sound data and frequency components. In a case where the sound pressure level of the specific frequency, which is included in the frequency components of the second sound data having directivity in first directivity direction dr2 of arbitrary directivity direction BF2, is equal to or larger than prescribed value th2, processor 26 determines that moving body dn exists in first directivity direction dr2. Sound source detection device 30 is an example of an object detection device. Moving body dn is an example of an object.

Therefore, in a case where sound source detection device 30 uses the non-directional microphones, for example, it is possible to collect sounds from moving body dn without rotating sound source detection device 30. In addition, since sound source detection device 30 collects omnidirectional sounds at once, there is no difference in sound collection time at each bearing, and thus sound source detection device 30 is capable of detecting sounds at the same timing. In addition, since an area in which it is difficult to perform object detection hardly occurs, sound source detection device 30 is capable of improving sensitivity of the object detection. Therefore, sound source detection device 30 is capable of improving detection accuracy of moving body dn.

In addition, processor 26 may sequentially change directivity range BF1 based on the first sound data, and may generate a plurality of items of third sound data having directivity in arbitrary directivity range BF1. In a case where the sound pressure level of the specific frequency, which is included in frequency components of third sound data having directivity in first directivity range dr1 of arbitrary directivity range BF1, is equal to or larger than prescribed value th1, processor 26 may switch over to the scan in directivity direction BF2 from the scan in directivity range BF1. That is, processor 26 may sequentially change directivity direction BF2 based on the first sound data, and may generate a plurality of items of second sound data having directivity in arbitrary directivity direction BF2 included in first directivity range dr1. In a case where the sound pressure level of the specific frequency, which is included in the frequency components of the second sound data having directivity in first directivity direction dr2 of arbitrary directivity direction BF2, is equal to or larger than prescribed value th2, processor 26 may determine that moving body dn exists in first directivity direction dr2. Also, directivity range BF1 is an example of the direction range.

Therefore, sound source detection device 30 performs the scan in directivity direction BF2 after performing the scan of directivity range BF1, with the result that scan efficiency is improved, and thus it is possible to reduce scan time.

In addition, in a case where the sound pressure level of the sound data having directivity in first directivity direction dr2 and the sound pattern of the frequency components approximate to a prescribed pattern, processor 26 may determine that moving body dn exists in first directivity direction dr2. The prescribed pattern is, for example, a sound pattern stored in memory 32A.

Therefore, in a case where characteristics (sound pattern) of the sound emitted by moving body dn are known in advance, sound source detection device 30 is capable of specifying moving body dn, and, furthermore, it is possible to improve detection accuracy of moving body dn.

In addition, in a case where the sound pressure level at the specific frequency, which is emitted by moving body dn and is registered in memory 32A, becomes large as time elapses, processor 26 may detect the approach of moving body dn. In addition, in a case where the approach of moving body dn is detected and the sound pressure level of the specific frequency is equal to or larger than prescribed value th3, processor 26 may determine that moving body dn exists in the warning area. The warning area is an example of a prescribed area.

Therefore, sound source detection device 30 is capable of notifying about the approach of moving body dn through display or the like.

In addition, object detection system 5 may include sound source detection device 30, omnidirectional camera CA, control box 10, and monitor 50. Sound source detection device 30 transmits the result of determination of existence of moving body dn to control box 10. Omnidirectional camera CA images an image having omnidirectional angle of view. Monitor 50 superimposes the positional information of moving body dn, which is determined to exist in first directivity direction dr2, on the omnidirectional image, which is imaged by omnidirectional camera CA, and displays a resulting image under control of control box 10. Omnidirectional camera CA is an example of a first camera. Control box 10 is an example of a control device.

The positional information of moving body dn is, for example, sound source direction image sp1.

Therefore, object detection system 5 is capable of visually check, for example, the position of moving body dn with respect to monitoring area 8.

### Modified Example Of First Embodiment

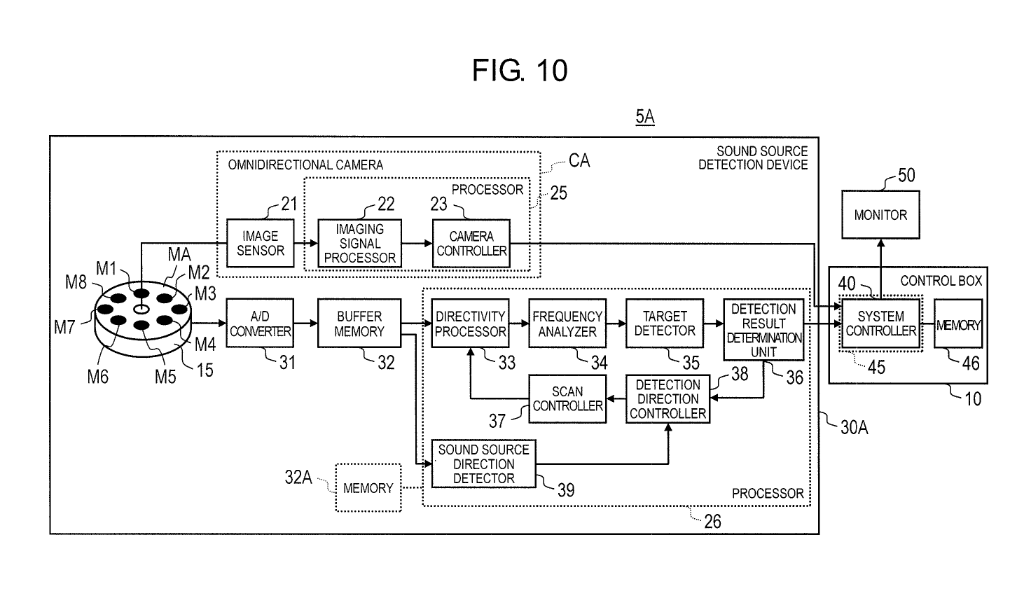

FIG. 10 is a block diagram illustrating a configuration of object detection system 5A according to a modified example of the first embodiment. Object detection system 5A includes sound source detection device 30A instead of sound source detection device 30, compared to object detection system 5. Sound source detection device 30A newly includes sound source direction detector 39, compared to sound source detection device 30.

Sound source direction detector 39 estimates a sound source position according to a well-known Cross-power Spectrum Phase analysis (CSP) method.

In the CSP method, sound source direction detector 39 estimates a sound source position in monitoring area 8 by dividing monitoring area 8 into a plurality of blocks and determining whether or not sounds which are larger than a threshold exist for each block in a case where the sounds are collected by microphone array MA.

A process of estimating the sound source position using the CSP method corresponds to the above-described process of detecting moving body dn by scanning directivity range BF1. Accordingly, in the modified example, in a case where sound source direction detector 39 estimates the sound source position, directivity direction BF2 is scanned in the estimated sound source position (corresponding to first directivity range dr1) and moving body dn is detected in first directivity direction dr2.

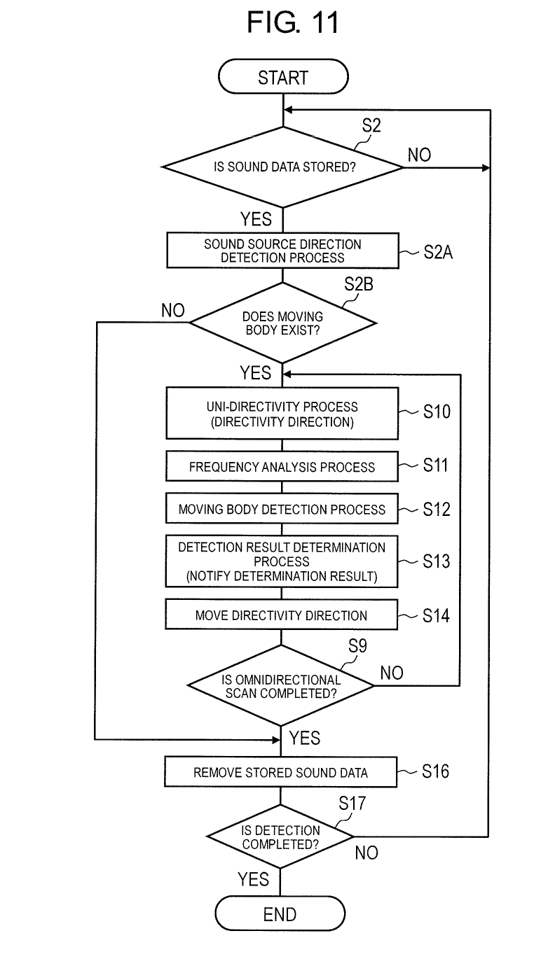

FIG. 11 is a flowchart illustrating a procedure of the process of detecting moving body dn by sound source detection device 30A according to the modified example. In FIG. 11, the same step numbers are attached to the same processes as in FIG. 7 or FIG. 8 and description thereof will be omitted. In the modified example, S1 and S3 to S9, which are related to the scan of directivity range BF1 and illustrated in FIG. 7, are omitted.

First, directivity processor 33 determines whether or not sounds are collected by microphone array MA, the sound data is converted into digital values by A/D converter 31, and the sound data is stored in buffer memory 32 (S2). In a case where the sound data is not stored, S2 is repeated.

In a case where the sound data is stored in buffer memory 32, sound source direction detector 39 estimates the sound source position according to the CSP method using the sound data (S2A).

Sound source direction detector 39 determines whether or not moving body dn is detected as the sound source as a result of the estimation of the sound source position (S2B).

In a case where the sound source is not detected, sound source detection device 30 removes the sound data stored in buffer memory 32 (S16).

In a case where the sound source is detected, processor 26 performs beam forming and the sequential scan in directivity direction BF2 at the sound source position (directivity range dr), and detects moving body dn (S10 to S14, and S9).

As above, in sound source detection device 30A, processor 26 may determine whether or not moving body dn exists in first directivity range dr1 according to the CSP method. Therefore, sound source detection device 30A is capable of omitting the scan of directivity range BF1, is capable of improving scan efficiency, and is capable of reducing the scan time.

### Second Embodiment

In a second embodiment, a case where a distance measurement device, which measures a distance up to moving body dn, is placed is illustrated.

[Configuration]

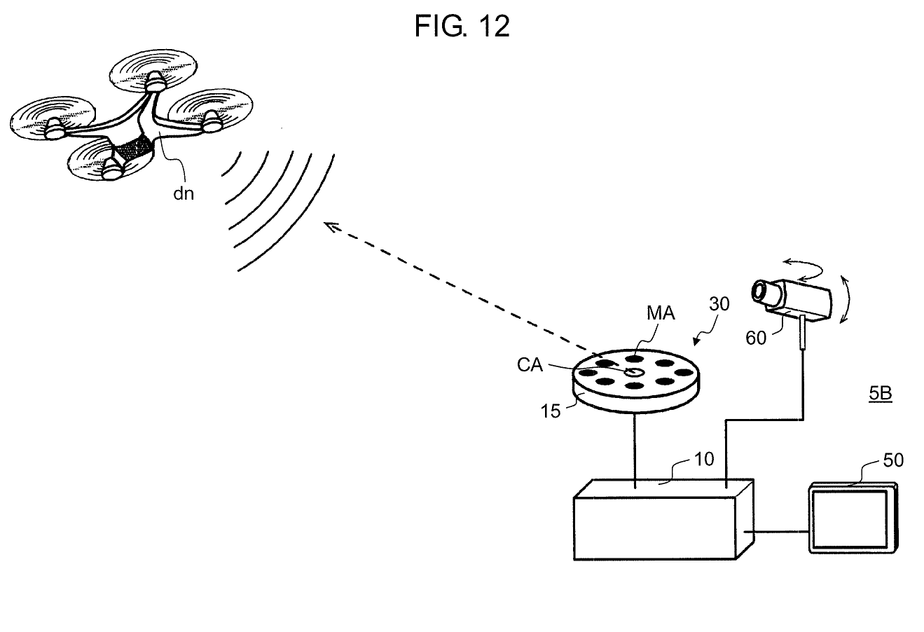

FIG. 12 is a schematic diagram illustrating a schematic configuration of object detection system 5B according to the second embodiment. In object detection system 5B, the same reference symbols are attached to the same components as in object detection systems 5 and 5A according to the first embodiment, and description thereof will be omitted or simplified.

Object detection system 5B includes sound source detection device 30 or 30A, control box 10, and monitor 50, similar to the first embodiment, and further includes distance measurement device 60.

Distance measurement device 60 measures a distance up to detected moving body dn. For example, a Time Of Flight (TOF) method is used as a distance measurement method. In the TOF method, ultrasonic waves and laser beams are projected toward moving body dn, and a distance is measured based on time until reflected waves and reflected beams are received. Here, a case where ultrasonic waves are used is illustrated.

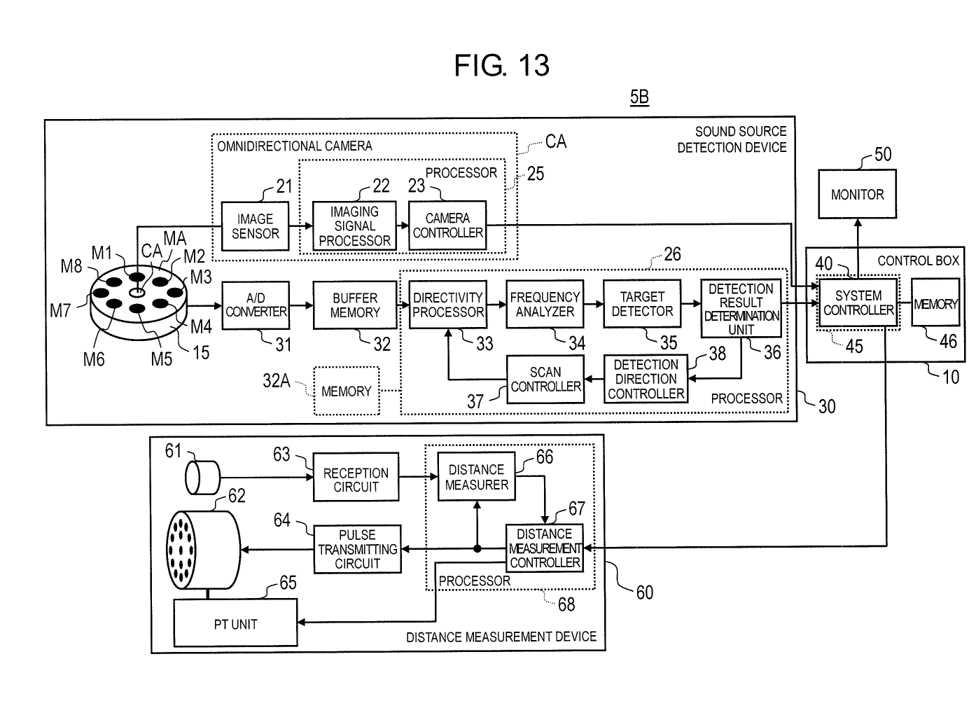

FIG. 13 is a block diagram illustrating a configuration of object detection system 5B. Distance measurement device 60 includes ultrasonic sensor 61, ultrasonic speaker 62, reception circuit 63, pulse transmitting circuit 64, distance measurer 66, distance measurement controller 67, and PT unit 65. Also, in a case where processor 68 executes a prescribed program, functions of distance measurer 66 and distance measurement controller 67 are realized.

Also, in a case where the laser beams are used, an invisible light sensor and an invisible laser diode are used instead of ultrasonic sensor 61 and ultrasonic speaker 62. The invisible light includes, for example, infrared light or ultraviolet light.

Ultrasonic speaker 62 changes an ultrasonic projection direction in a case in a case where PT unit 65 is driven, and projects the ultrasonic waves toward moving body dn. The ultrasonic waves are projected, for example, in a pulse shape.

Ultrasonic sensor 61 receives reflected waves which are projected by ultrasonic speaker 62 and reflected in moving body dn.

Reception circuit 63 processes a signal from ultrasonic sensor 61, and transmits the signal to distance measurer 66.

Pulse transmitting circuit 64 generates pulse-shaped ultrasonic waves projected from ultrasonic speaker 62 and transmits the generated ultrasonic waves to ultrasonic speaker 62 under control of distance measurement controller 67.

PT unit 65 includes a drive mechanism which has a motor or the like that causes ultrasonic speaker 62 to turn in a pan (P) direction and a tilt (T) direction.

Distance measurer 66 measures the distance up to moving body dn based on the signal from reception circuit 63 under control of distance measurement controller 67. For example, distance measurer 66 measures the distance up to moving body dn and outputs a result of measurement of the distance to distance measurement controller 67 based on transmission time in which the ultrasonic waves are transmitted from ultrasonic speaker 62 and reception time in which the reflected waves are received by ultrasonic sensor 61.

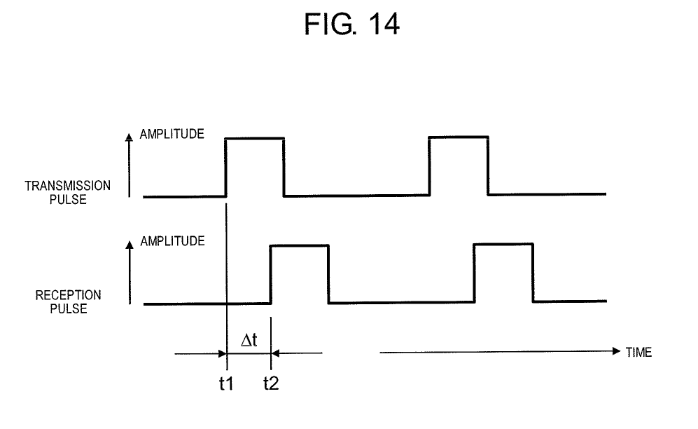

FIG. 14 is a timing chart illustrating a distance measurement method.

FIG. 14 illustrates time difference between a pulse signal (transmission pulse) of the ultrasonic wave which is projected and a pulse signal (reception pulse) of the ultrasonic wave which is reflected in moving body dn. In a case where it is assumed that difference between projection timing t1 and light reception timing t2 is time difference Δt, distance measurer 66 calculates a distance L up to moving body dn according to, for example, (Equation 1).

Distance L=sound speed C×time difference Δt/2 (Equation 1)

Also, sound speed C is acquired in, for example, (Equation 2) using temperature T of dry air.

Sound speed C=331.5+0.6T (Equation 2)

Distance measurement controller 67 generalizes respective units of distance measurement device 60. Distance measurement controller 67 transmits information of the distance up to moving body dn, which is detected by distance measurer 66, to control box 10. Distance measurement controller 67 receives information of a direction (corresponding to the directivity direction), in which moving body dn exists, from control box 10, and instructs PT unit 65 to turn such that ultrasonic speaker 62 faces moving body dn.

Control box 10 includes memory 46 registered with a warning distance used to determine whether or not moving body dn invades warning area. System controller 40 determines whether or not the distance up to moving body dn, which is detected by distance measurer 66, is included within the warning distance registered in memory 46. In addition, system controller 40 may display the image, which is imaged by omnidirectional camera CA, on monitor 50 such that the information of the distance up to moving body dn is included.

[Operation]

Subsequently, an operation example of object detection system 5B will be described.

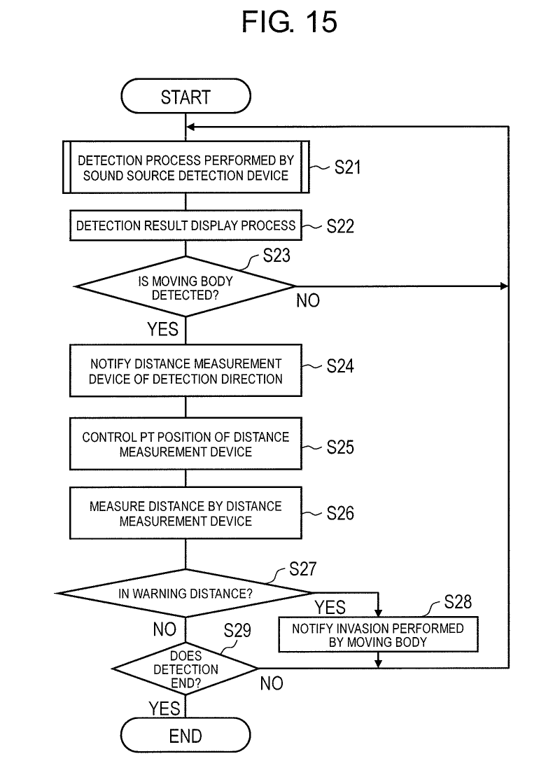

FIG. 15 is a flowchart illustrating an operation example of object detection system 5B. Here, although sound source detection device is illustrated as sound source detection device 30, sound source detection device may be sound source detection device 30A (and so forth).

First, object detection system 5B performs the process of detecting moving body dn using sound source detection device 30 (S21). A process in S21 is the process illustrated in, for example, FIG. 7, FIG. 8, or FIG. 11.

In a case where system controller 40 receives the result of the detection of moving body dn from sound source detection device 30, system controller 40 causes monitor 50 to display the result of the detection of moving body dn (S22). In a case where moving body dn is detected, for example, sound source direction image sp1, in which a mechanical sound generated by moving body dn is used as the sound source, is superimposed on omnidirectional image GZ1, and a resulting image is displayed on monitor 50, as illustrated in FIG. 9.

System controller 40 determines whether or not moving body dn is detected based on the result of the detection of moving body dn from sound source detection device 30 (S23). In a case where moving body dn is not detected, system controller 40 returns to the process in S21.

In a case where moving body dn is detected in S23, system controller 40 notifies distance measurement device 60 of information of a position of detected moving body dn (S24). Here, the position of moving body dn corresponds to a direction of moving body dn with respect to sound source detection device 30 and corresponds to the first directivity direction dr2.

Distance measurement controller 67 drives PT unit 65, and provides an instruction such that a direction of ultrasonic speaker 62 becomes the notified direction of moving body dn (S25).

Distance measurer 66 measures the distance up to moving body dn under the control of distance measurement controller 67 (S26). Also, the distance up to moving body dn from distance measurement device 60 is the distance up to moving body dn from sound source detection device 30 to the same extent. Distance measurer 66 projects the ultrasonic wave, for example, toward moving body dn from ultrasonic speaker 62, and measures the distance up to moving body dn based on time until the reflected wave is received by ultrasonic sensor 61.

System controller 40 determines whether or not the measured distance up to moving body dn is included within the warning distance stored in memory 46 (S27).

In a case where the measured distance up to moving body dn is included within the warning distance, system controller 40 provides a notification that the warning area is invaded by moving body dn to the monitor 50 (S28). In a case where monitor 50 receives the notification about the invasion performed by moving body dn, monitor 50 displays information which indicates that moving body dn enters the warning area. Therefore, the user views a screen of monitor 50, to which the notification about the invasion performed by moving body dn is provided, thereby being capable of recognizing that a high urgency situation is generated.

Subsequent to the process in S28, system controller 40 returns to S21.

In contrast, in a case where the distance up to moving body dn, which is measured in S27, is equal to or longer than the warning distance, system controller 40 determines whether or not to end various processes in FIG. 15 (the process of detecting existence of moving body dn and measuring the distance up to moving body dn and the process of determining the invasion performed by moving body dn) (S29).

In a case where the various processes in FIG. 15 do not end, system controller 40 returns to the process in S21 and repeats the various processes in FIG. 15. In contrast, in a case where the various processes in FIG. 15 end in S29, object detection system 5B ends the processes in FIG. 15. For example, in a case where power of control box 10 is turned off, the processes in FIG. 15 may end.

Also, system controller 40 may cause monitor 50 to superimpose the sound source direction image sp1 on omnidirectional image GZ1, to display a resulting image, and to display information of the distance up to moving body dn.

In this case, for example, system controller 40 may change a display form of sound source direction image sp1 based on the distance up to moving body dn. In addition, system controller 40 may change the display form of sound source direction image sp1 based on whether or not moving body dn exists in the warning area. The display form includes, for example, a display color, a size, a form, and a type of sound source direction image sp1. In addition, distance information may be coordinate information.

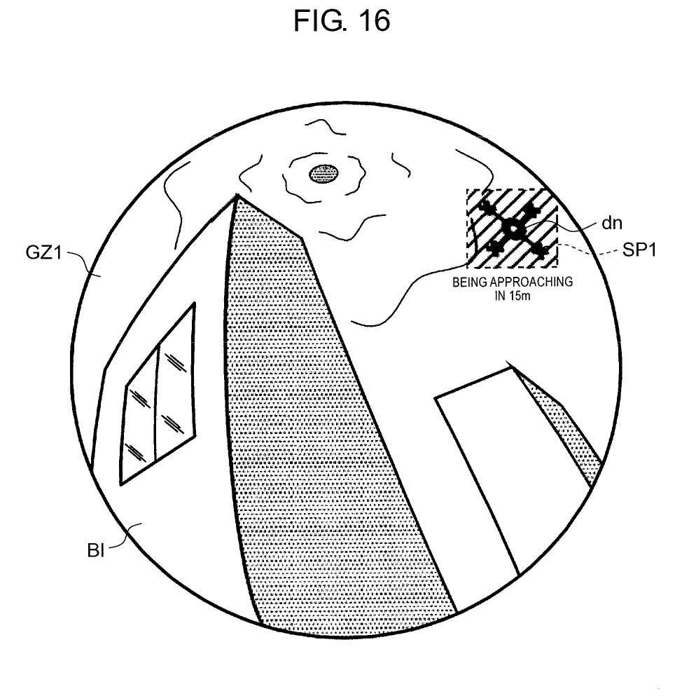

FIG. 16 is a schematic diagram illustrating omnidirectional image GZ1 which is imaged by omnidirectional camera CA.

In FIG. 16, omnidirectional image GZ1 includes moving body dn which flies from a valley of building B1, similar to FIG. 9. For example, sound source direction image sp1 of moving body dn may be displayed in such a way that sound source direction image sp1 is superimposed on omnidirectional image GZ1 through the display form (displayed by hatching in the drawing), which indicates that moving body dn exists in the warning area. In addition, character information indicative of the distance up to moving body dn (“being approaching in 15 m” in FIG. 16) may be displayed.

[Effect]

As above, distance measurement device 60 may change distance measurement direction in a case where PT unit 65 is driven, and may measure the distance up to moving body dn which exists in first directivity direction dr2 using microphone array MA as a reference point. Distance measurement device 60 may transmit the result of the measurement of the distance to control box 10. In a case where the measured distance is included within the warning distance, control box 10 may determine that moving body dn exists in the warning area. PT unit 65 is an example of an actuator.

Also, in a case where processor executes the prescribed program, a function of system controller 40 is realized. The warning distance is an example of a predetermined distance. The warning area is an example of a prescribed area.

Therefore, object detection system 5B is capable of measuring the distance up to moving body dn which is detected by sound source detection device 30. In addition, in a case where omnidirectional image GZ1 and sound source direction image sp1 are displayed on monitor 50 in a display state according to the distance up to moving body dn, the user is capable of visually recognizing the position of moving body dn (a three-dimensional position in the sound collection space). Furthermore, the user is capable of recognizing an approach degree of moving body dn to the warning area, and is capable of strengthening surveillance mechanism if necessary.

### Third Embodiment

In a third embodiment, a case where a PTZ camera is placed in addition to distance measurement device 60 is illustrated.

[Configuration]

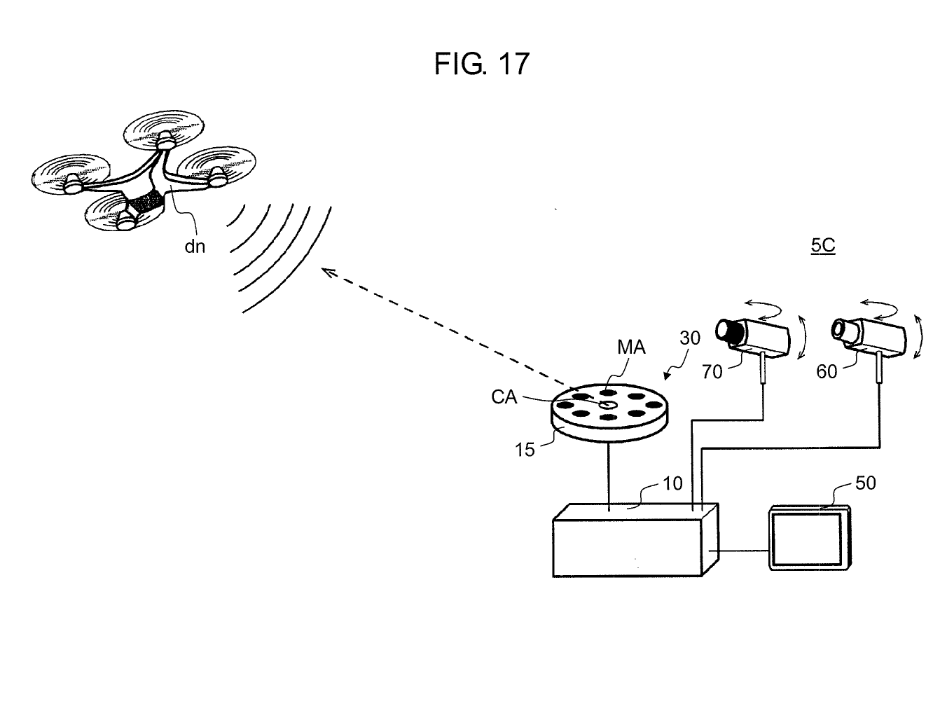

FIG. 17 is a schematic diagram illustrating a schematic configuration of object detection system 5C according to the third embodiment. In object detection system 5C, the same reference symbols are attached to the same components as in object detection systems 5, 5A, and 5B according to the first and second embodiments, and description thereof will be omitted or simplified.

Object detection system 5C includes sound source detection device 30 or 30A, control box 10, monitor 50, and distance measurement device 60 similar to the second embodiment, and, furthermore, includes PTZ camera 70.

PTZ camera 70 is a camera which is capable of turning the imaging direction in the pan (P) direction and the tilt (T) direction and is capable of varying zoom magnification (Z). PTZ camera 70 is used as, for example, a monitoring camera.

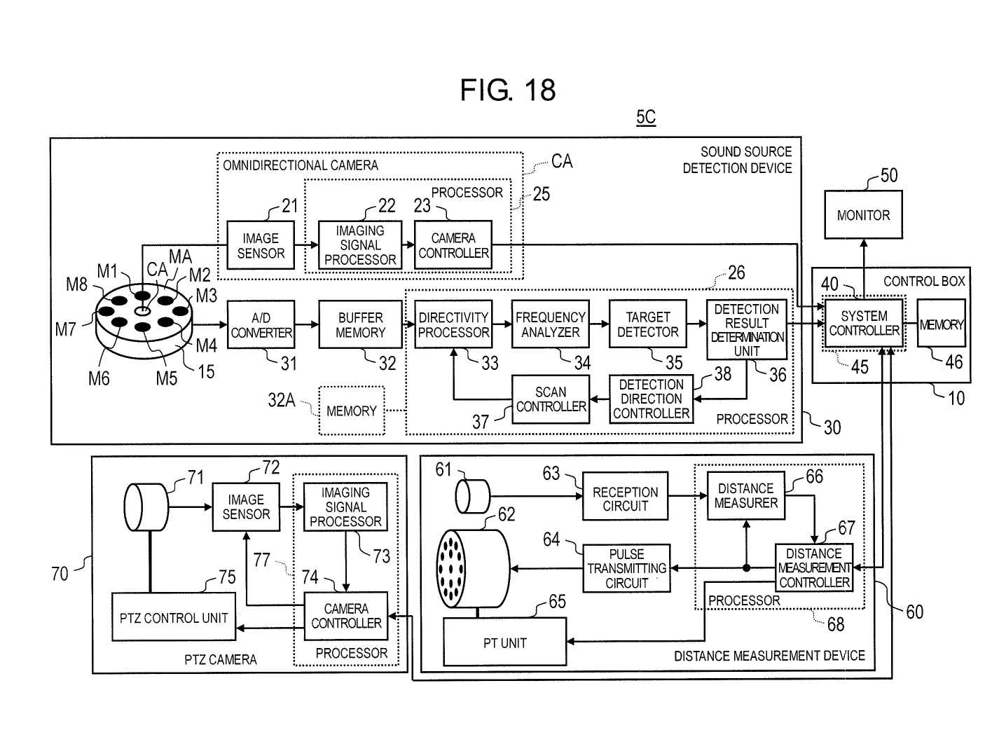

FIG. 18 is a block diagram illustrating a configuration of object detection system 5C. PTZ camera 70 includes zoom lens 71, image sensor 72, imaging signal processor 73, camera controller 74, and PTZ control unit 75. Also, in a case where processor 77 executes a prescribed program, respective functions of imaging signal processor 73 and camera controller 74 are realized.

Zoom lens 71 is a lens which is built in a lens barrel and is capable of changing the zoom magnification. Zoom lens 71 changes the zoom magnification in a case where PTZ control unit 75 is driven. In addition, the lens barrel turns in the pan direction and the tilt direction in a case where PTZ control unit 75 is driven.

Image sensor 72 is a solid state imaging device such as CCD or CMOS. Imaging signal processor 73 converts a signal, which is imaged by image sensor 72, into an electric signal, and performs various image processes.

Imaging signal processor 73 performs various image processes on the image signal captured by the image sensor 72. Camera controller 74 generalizes operations of respective units of PTZ camera 70, and supplies a timing signal to, for example, image sensor 72.

PTZ control unit 75 includes a driving mechanism, such as a motor, which changes the pan direction and the tilt direction of the lens barrel and changes the zoom magnification of zoom lens 71.

[Operation]

Subsequently, an operation example of object detection system 5C will be described.

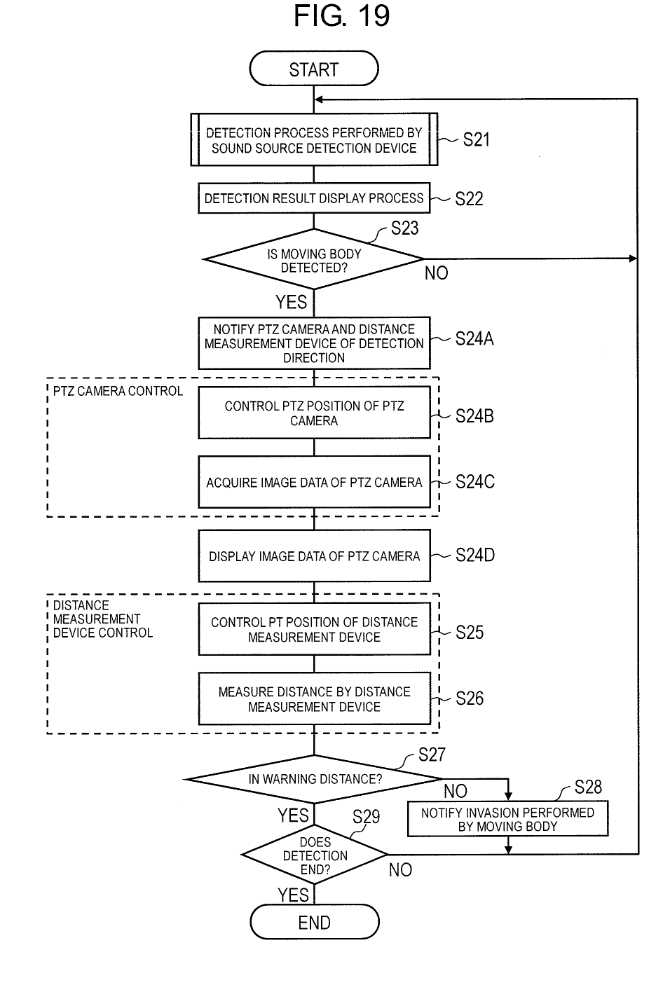

FIG. 19 is a flowchart illustrating an operation example of object detection system 5C. Here, the same step numbers are attached to the same processes as the processes illustrated in FIG. 15 according to the second embodiment, and description thereof will be omitted or simplified.

In a case where moving body dn is detected in S23, system controller 40 notifies PTZ camera 70 and distance measurement device 60 of the information of the position of detected moving body dn (S24A). Here, the position of moving body dn corresponds to the direction of moving body dn with respect to sound source detection device 30, and corresponds to first directivity direction dr2.

In a case where a notification of the information of the position of moving body dn is received, PTZ camera 70 changes the imaging direction to the direction of moving body dn in a case where PTZ control unit 75 is driven. In addition, zoom lens 71 changes the zoom magnification such that moving body dn is imaged in a prescribed size in a case where PTZ control unit 75 is driven (S24B).

Image sensor 72 acquires the image data which is imaged through zoom lens 71 (S240. The image processing is performed on image data if necessary and resulting image data is transmitted to system controller 40.

In a case where system controller 40 acquires the image data from PTZ camera 70, system controller 40 displays the image on monitor 50 based on the acquired image data (S24D).

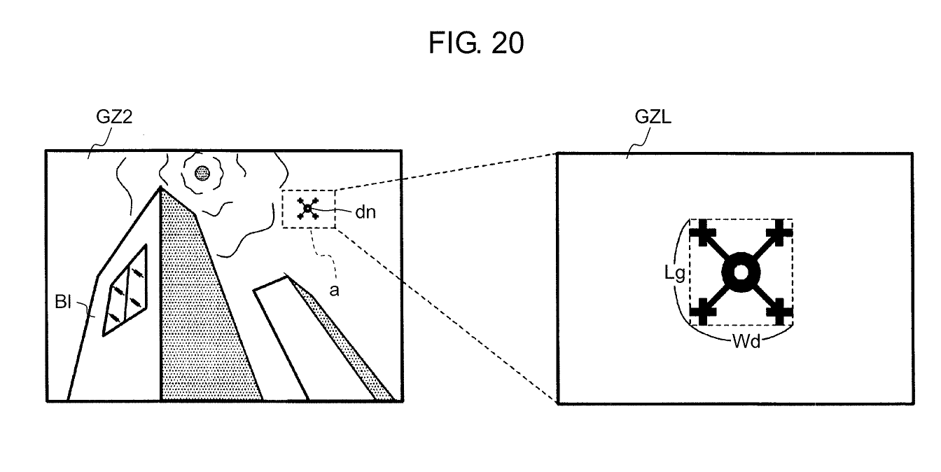

FIG. 20 is a schematic diagram illustrating an image which is imaged by PTZ camera 70.

PTZ image GZ2, which is imaged by PTZ camera 70, includes moving body dn which flies above building B1. Zoom lens 71 changes the zoom magnification such that a size of moving body dn becomes a prescribed size with respect to the angle of view in a case where PTZ control unit 75 is driven. In a case where the zoom magnification is changed, a part, which is a part of PTZ image GZ2 including moving body dn and is surrounded by a rectangle a, is enlarged and displayed. In enlargement image GZL, which is enlarged and displayed, the size of moving body dn is displayed by a rectangular frame (length Lg×width Wd).

Processes, which are subsequent to the process in S25 after the process in S24D, are the same as in the second embodiment.

In S29, system controller 40 determines whether or not to end the various processes (the process of detecting existence of moving body dn and measuring the distance up to moving body dn, the process of displaying moving body dn, and the process of determining the invasion performed by moving body dn) of FIG. 19. In a case where the various processes of FIG. 19 do not end, system controller 40 returns to the process in S21. In contrast, in a case where the various processes of FIG. 19 end, system controller 40 ends the processes of FIG. 19.

Also, system controller 40 may estimate the size of moving body dn based on the distance up to moving body dn and the size of moving body dn which occupies displayed PTZ image GZ2 or enlargement image GZL. Memory 46 of control box 10 may maintain size information (size range information), which is assumed as a size of a detection target object, in advance.

In addition, in a case where the estimated size of moving body dn is included in a size range maintained in memory 46, system controller 40 may further estimate that moving body dn is the detection target. In this case, object detection system 5B is capable of roughly recognizing the actual size of moving body dn and is capable of easily specifying a model of moving body dn.

[Effect]

As above, PTZ camera 70 may change the imaging direction in a case where PTZ control unit 75 is driven and may image moving body dn which exists in first directivity direction dr2. In addition, control box 10 may estimate the size of moving body dn based on a size of an area of moving body dn in PTZ image GZ2, which is imaged by PTZ camera 70, and the distance up to moving body dn from microphone array MA. In a case where the size of moving body dn is included in a prescribed size, it may be determined that moving body dn is the detection target. PTZ control unit 75 is an example of an actuator.

Therefore, object detection system 5B is capable of acquiring an image based on moving body dn. Therefore, the user is capable of visually recognizing the characteristic of moving body dn easily. In addition, since object detection system 5B is capable of estimating whether or not the detection target is based on the size of moving body dn in addition to the sounds emitted by moving body dn, it is possible to further improve the detection accuracy of moving body dn.

### Fourth Embodiment

In a fourth embodiment, an object detection system, in which PTZ camera 70 is placed similar to the third embodiment but distance measurement device 60 is omitted, will be described.

[Configuration]

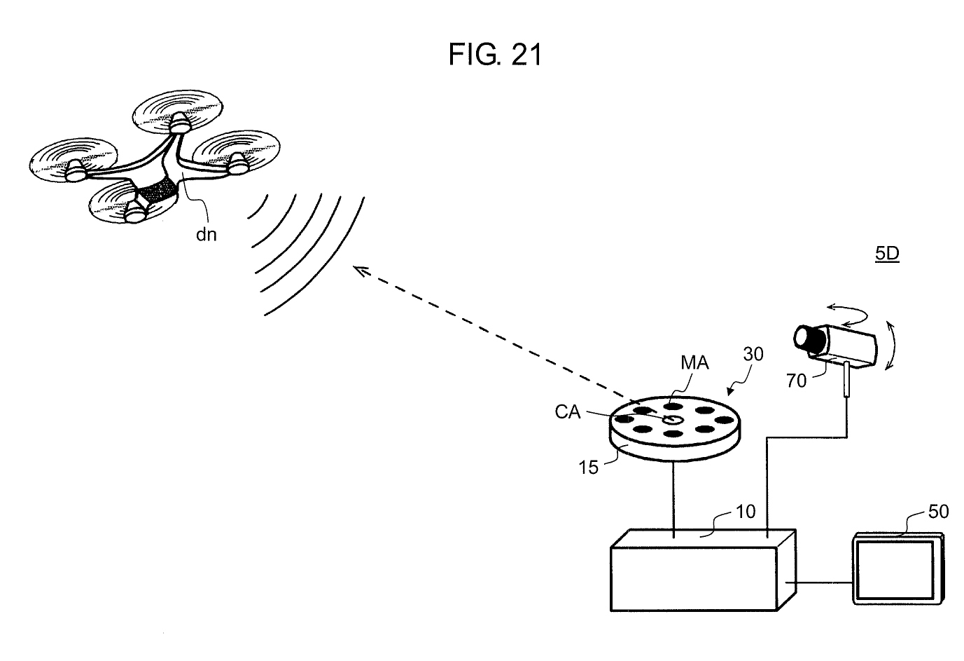

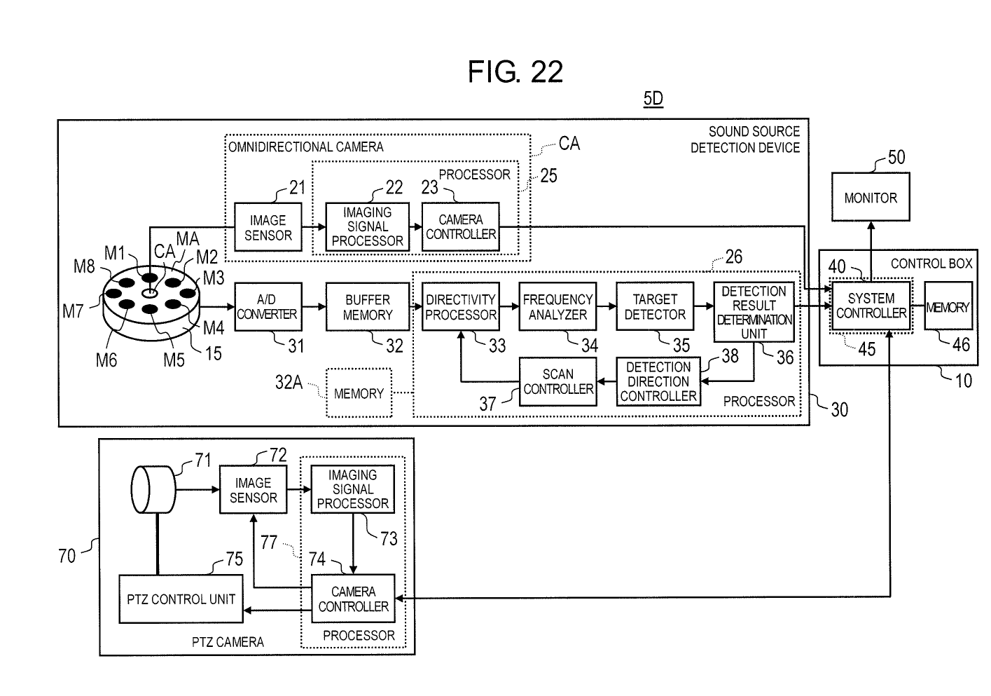

FIG. 21 is a schematic diagram illustrating a schematic configuration of object detection system 5D according to the fourth embodiment. In object detection system 5D, the same reference symbols are attached to the same components as in object detection systems 5, 5A, 5B and 5C according to the first to third embodiments, and description thereof will be omitted or simplified.

Object detection system 5D includes sound source detection device 30 or 30A, control box 10, monitor 50, and PTZ camera 70.

[Operation]

Subsequently, an operation example of object detection system 5D will be described.

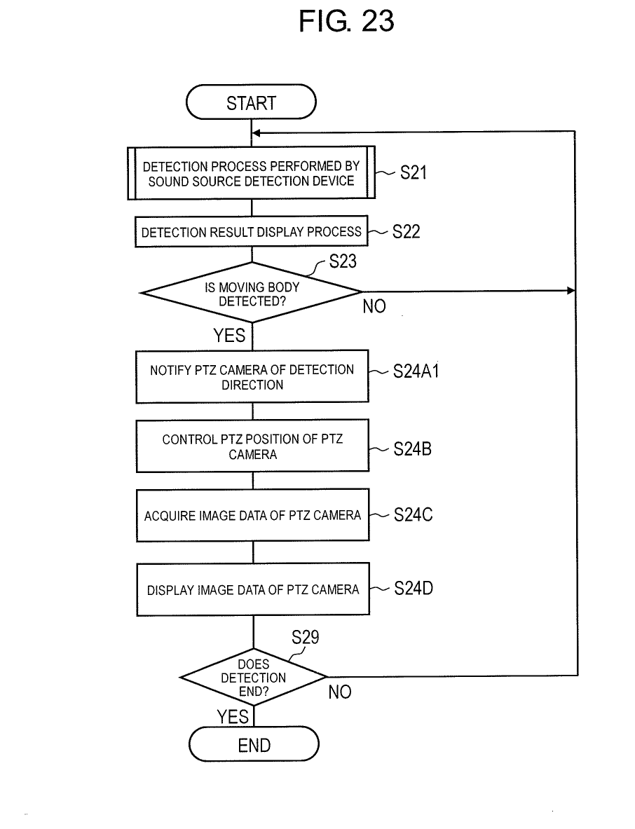

FIG. 23 is a flowchart illustrating the operation example of object detection system 5D. Processes in FIG. 23 are performed while omitting the processes in S25 to S28 in the flowchart illustrated in FIG. 19 according to the third embodiment.

That is, in a case where moving body do is detected in S23, system controller 40 notifies PTZ camera 70 of the information of the position of detected moving body dn (S24A1). In a case where system controller 40 displays an image, which is imaged by PTZ camera 70, on monitor 50 in S24D, system controller 40 determines whether or not to end various processes (the process of detecting moving body dn and the process of displaying moving body dn) of FIG. 23 in S29. In a case where the various processes of FIG. 23 do not end, system controller 40 returns to the process in S21. In contrast, in a case where the various processes of moving body dn end, system controller 40 ends the processes of FIG. 23.

[Effect]

As above, in a case where moving body dn is detected, object detection system 5B is capable of projecting moving body dn largely on an image which is imaged by PTZ camera 70. Therefore, the user is capable of visually recognizing the characteristic of moving body dn easily.

### Fifth Embodiment

In a fifth embodiment, an object detection system, which includes a plurality of (for example, two) sound source detection devices, is illustrated.

[Configuration]

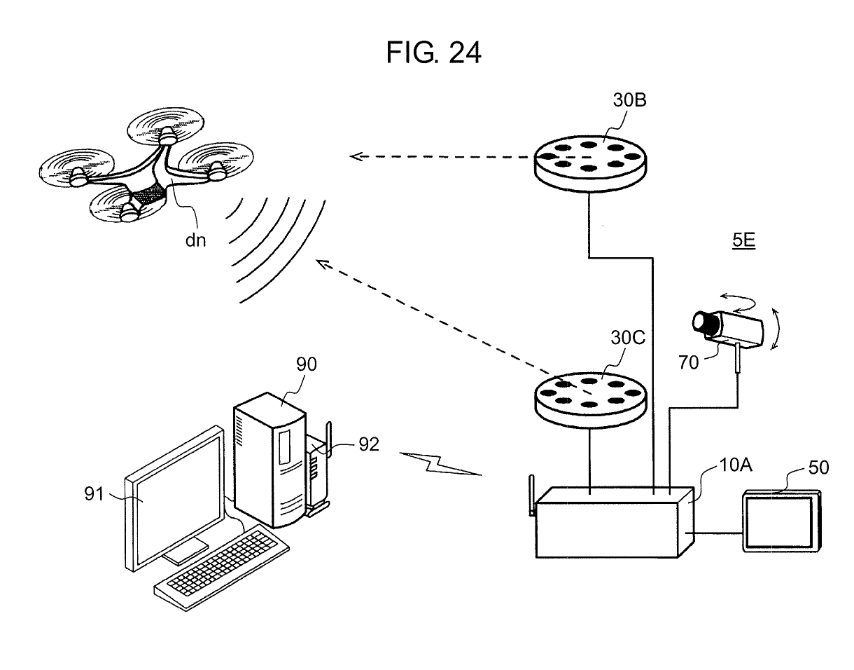

FIG. 24 is a schematic diagram illustrating a schematic configuration of object detection system 5E according to the fifth embodiment. In object detection system 5E, the same reference symbols are attached to the same components as in object detection systems 5, 5A, 5B, 5C, and 5D according to the first to fourth embodiments and description thereof will be omitted or simplified.

Object detection system 5E according to the fifth embodiment is connected to, for example, monitoring device 90, which is installed in a management office in a facility, such that communication is possible. For example, control box 10A is connected to monitoring device 90 such that wired communication or wireless communication is possible.

Object detection system 5E includes a plurality of (for example, two) sound source detection devices 30 (30B and 30C), control box 10A, and PTZ camera 70.

Monitoring device 90 includes a computer device which has display 91, a wireless communication device 92, and the like. Monitoring device 90 displays, for example, an image which is transmitted from object detection system 5E. Therefore, an observer is capable of performing monitoring on monitoring area 8 using monitoring device 90.

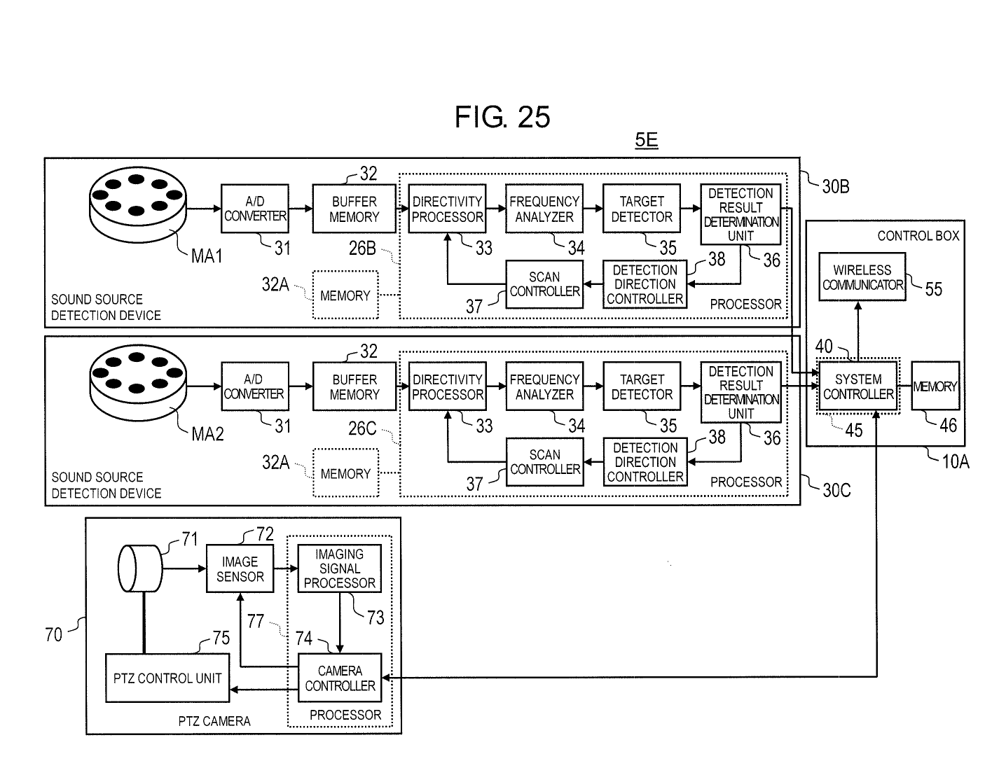

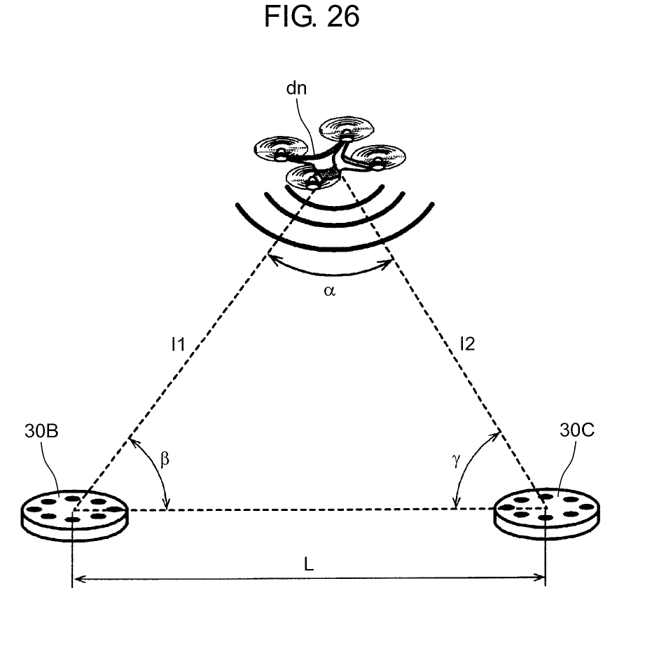

FIG. 25 is a block diagram illustrating a configuration of object detection system 5E. Sound source detection device 30B performs beam forming with respect to omnidirectional sounds collected by microphone array MA1, and emphasizes the sounds in the directivity direction thereof. Sound source detection device 30C performs beam forming with respect to omnidirectional sounds collected by microphone array MA2, and emphasizes the sounds in the directivity direction thereof.

Also, configurations and operations of sound source detection devices 30B and 30C are the same as in sound source detection device 30 according to the above-described embodiment.

System controller 40 calculates the distance up to moving body dn based on the directivity direction (angle β of FIG. 26) in which moving body dn is detected by sound source detection device 30B and the directivity direction (angle γ of FIG. 26) in which moving body dn is detected by sound source detection device 30C.

Also, sound source detection devices 30B and 30C include omnidirectional camera CA similar to the first to fourth embodiments.

FIG. 26 is a schematic diagram illustrating a method for measuring the distance up to a moving body dn using two sound source detection devices 30B and 30C.

It is assumed that a distance between microphone array MA1 and microphone array MA2 is already known as a length L[m]. In this case, system controller 40 calculates distance l1 up to moving body dn from microphone array MA1 and distance l2 up to moving body dn from microphone array MA2 based on (Equation 3) and (Equation 4), respectively, using, for example, trigonometry.

l1=L×sinγ/sinα (Equation 3)

l2=L×sinγ/sinα (Equation 4)

Control box 10A includes system controller 40 and wireless communicator 55. Wireless communicator 55 is wirelessly connected to wireless communication device 92 of monitoring device 90 such that communication is possible. Wireless communicator 55 transmits, for example, the position of moving body dn (detection direction), the distance up to moving body dn, and image data which is imaged by PTZ camera 70 to monitoring device 90. In addition, wireless communicator 55 receives, for example, a remote control signal from monitoring device 90, and sends the remote control signal to system controller 40.

[Operation]

Subsequently, an operation example of object detection system 5E will be described.

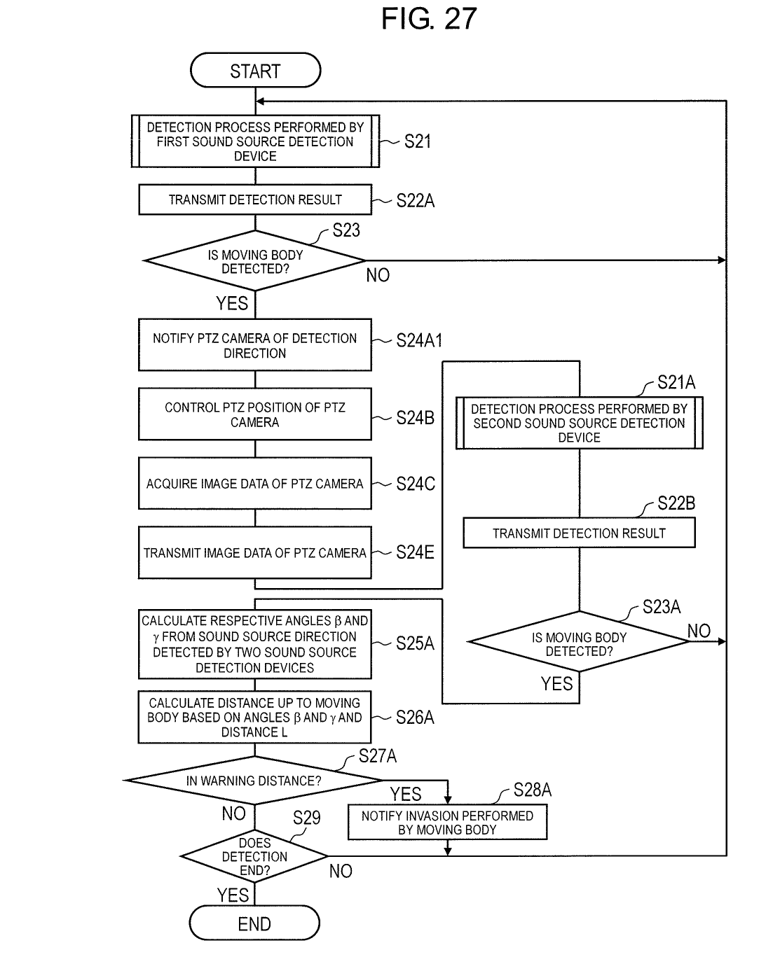

FIG. 27 is a flowchart illustrating an operation example of object detection system 5E. In FIG. 27, the same step numbers are attached to the same processes as in FIG. 19 according to the third embodiment, and description thereof will be omitted or simplified.

First, sound source detection device 30B, which functions as a first sound source detection device, performs the processes illustrated in FIG. 7 or FIG. 11 according to the first embodiment (S21).

In control box 10A, in a case where system controller 40 receives a detection result of moving body dn from sound source detection device 30B, wireless communicator 55 transmits the detection result of moving body dn to monitoring device 90 (S22A). In a case where monitoring device 90 receives the detection result of moving body dn from object detection system 5E, monitoring device 90 displays the detection result of moving body dn on display 91.

In a case where moving body dn is not detected in S23, system controller 40 returns to the process in S21.

In a case where moving body dn is detected in S23, system controller 40 notifies PTZ camera 70 of the information of the position of moving body dn (S24A1).

In a case where system controller 40 acquires the image, which is acquired from PTZ camera 70 in S24C, system controller 40 transmits the image to monitoring device 90 (S24E).

Similarly, sound source detection device 30C, which functions as a second sound source detection device, performs the processes illustrated in FIG. 7 or FIG. 11 according to the first embodiment (S21A).

In control box 10A, in a case where system controller 40 receives the detection result of moving body dn from sound source detection device 30C, wireless communicator 55 transmits the detection result of moving body dn to monitoring device 90 (S22B).

System controller 40 determines whether or not moving body dn is detected based on the detection result from sound source detection device 30C (S23A). In a case where moving body dn is detected, system controller 40 acquires the information of the position of moving body dn from the detection result of moving body dn.

In a case where moving body dn is not detected in S23A, system controller 40 returns to the process in S21.

In a case where moving body dn is detected in S23A, system controller 40 calculates angle β (refer to FIG. 26) made by sound source detection device 30C and moving body dn with respect to sound source detection device 30B based on the detection direction of moving body dn, which is detected by sound source detection device 30B (S25A). Similarly, system controller 40 calculates angle γ (refer to FIG. 26) made by sound source detection device 30B and moving body dn with respect to sound source detection device 30C based on the detection direction of moving body dn, which is detected by sound source detection device 30C (525A).

System controller 40 calculates distance l1 and distance l2 according to, for example, (Equation 3), (Equation 4) based on angles β and γ, which are acquired in S25A, and distance L between microphone array MA1 and microphone array MA2 (S26A). Distance l1 is a distance up to moving body dn from sound source detection device 30B. Distance l2 is a distance up to moving body dn from sound source detection device 30C.

System controller 40 determines whether or not distance l1 or distance 12 is included within warning distance lm (S27A). In addition, system controller 40 may determine whether or not distance l3 based on distance l1 and distance l2 is included within warning distance lm.

In a case where any one of distances l1 to l3 is included within warning distance lm, system controller 40 notifies monitoring device 90 of the invasion performed by moving body dn through wireless communicator 55 (S28A).

Also, in a case where both distance l1 and distance l2 are included within warning distance lm, system controller 40 may determine that moving body dn invades.

Subsequent to process in S28A, system controller 40 returns to the process in S21.

In contrast, in a case where all distances l1 to l3 are not included in warning distance lm, system controller 40 determines whether or not to perform various processes (process of detecting existence of moving body dn and measuring the distance up to moving body dn and a process of determining whether or not moving body dn invades) of FIG. 27 (S29).

In a case where the detection process of FIG. 27 does not end, system controller 40 returns to the process in S21 and repeats the various processes of FIG. 27. In contrast, in a case where the various processes of FIG. 27 ends in S29, object detection system 5E ends the processes of FIG. 27.

[Effect]

As above, object detection system 5E may include sound source detection device 30B which detects moving body dn using microphone array MA1, and sound source detection device 30C which detects moving body dn using microphone array MA2. Control box 10A may derive the distance l1 or I2 from sound source detection device 30B or sound source detection device 30C to moving body dn based on the directivity direction in which moving body dn detected by sound source detection device 30B exists, the directivity direction in which moving body dn detected by sound source detection device 30C exists, and distance L between sound source detection devices 30B and 30C. In a case where the derived distance l1 or l2 is included within warning distance lm, system controller 40 may determine that moving body dn exists in the warning area. Sound source detection devices 30B and 30C are examples of the object detection device.

Therefore, object detection system 5E includes a plurality of microphone arrays MA1 and MA2, and thus it is possible to measure the distance up to moving body dn even though the distance measurement device is omitted. In addition, in a case where the distance up to moving body dn exists within warning distance, object detection system 5E is capable of notifying the user of a fact that moving body dn exists nearby. In addition, since the plurality of microphone arrays MA1 and MA2 are used, it is possible to enlarge the sound collection area of the sounds generated by moving body dn.

In addition, for example, in a case where the distance up to moving body dn is included within a prescribed distance, monitoring device 90 may output an alert while assuming that, for example, moving body dn invades warning area. The alert may be performed using various methods such as display, voice, and vibration.

### Sixth Embodiment

In a sixth embodiment, a configuration of a sound source detection unit, which is different from the configurations in the first to fifth embodiments, will be described. Sound source detection units UD according to the first to fifth embodiments may include a configuration of sound source detection unit UD1 described according to the sixth embodiment. In other words, sound source detection unit UD1 described according to the sixth embodiment may use the sound source detection units according to the first to fifth embodiments.

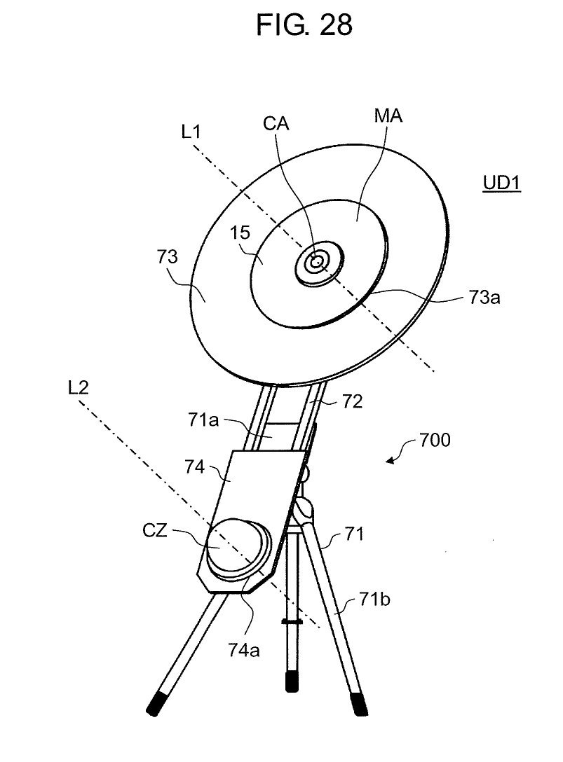

FIG. 28 is a diagram illustrating an example of an appearance of sound source detection unit UD1 according to the sixth embodiment. Sound source detection unit UD1 includes microphone array MA, omnidirectional camera CA, PTZ camera CZ, which are described above, and support 700 which mechanically supports microphone array MA, omnidirectional camera CA, PTZ camera CZ. Support 700 has a structure in which tripods 71, two rails 72 fixed to top board 71a of tripods 71, and first mounting plate 73 and second mounting plate 74, which are respectively attached to both end parts of two rails 72, are combined.

First mounting plate 73 and second mounting plate 74 are attached across two rails 72 and have substantially the same planes. In addition, first mounting plate 73 and second mounting plate 74 are capable of sliding on two rails 72 and are adjusted and fixed to positions which are separated from each other or approach to each other.

First mounting plate 73 is a disk-shape board. Opening 73a is formed at the center of first mounting plate 73. Housing 15 of microphone array MA is accommodated and fixed to opening 73a. In contrast, second mounting plate 74 is a substantially rectangular-shaped board. Opening 74a is formed at a part which is near to the outside of second mounting plate 74. PTZ camera CZ is accommodated in and fixed to opening 74a.

As illustrated in FIG. 28, optical axis L1 of omnidirectional camera CA accommodated in housing 15 of microphone array MA and optical axis L2 of PTZ camera CZ attached to second mounting plate 74 are respectively set to be parallel in an initial installation state.

Tripods 71 are supported by three legs 71b on a ground plane, are capable of moving the position of top board 71a in a vertical direction with respect to the ground plane through a manual operation, and are capable of adjusting a direction of top board 71a in the pan direction and the tilt direction. Therefore, it is possible to set the sound collection area of microphone array MA (in other words, an imaging area of omnidirectional camera CA) in an arbitrary direction.

### Another Embodiment

As described above, the first to sixth embodiments are described as examples of the technology according to the present disclosure. However, the technology according to the present disclosure is not limited thereto, and may be applied to an embodiment on which change, replacement, addition, omission, and the like are performed. In addition, the respective embodiments may be combined.

In the first to sixth embodiments, moving body dn is described as an example of an object (target). However, moving body dn may be an unmanned flying object or a manned flying object. In addition, moving body dn is not limited to an object which flies in a space, and may be an object which moves along a ground surface. Furthermore, the object may be a stationary object which does not move. In addition, the stationary object may be detected by changing relative positional relation between the stationary object and the object detection system in such a way that a transport device, in which any one of object detection system 5 and 5A to 5E according to the first to sixth embodiments is placed, moves with respect to the stationary object.

In the first to sixth embodiments, sounds emitted by moving body do include sounds in an audible frequency band (20 Hz to 20 kHz) or sounds in ultrasonic waves (which are equal to or higher than 20 kHz) or ultra-low frequencies (which are lower than 20 Hz) out of a range of the audible frequency band.

In the first to sixth embodiments, an example, in which microphone array MA, control boxes 10 and 10A, monitor 50, and the like are individually formed as independent devices and the object detection system includes the devices, is described. Also, the embodiments may be realized as an object detection device in which microphone array MA, control boxes 10 and 10A, monitor 50, and the like are accommodated in a single housing. The object detection device has convenience as a portable device.

In the first to sixth embodiments, an example, in which processors 25, 26, 26B, and 26C are provided in the sound source detection device, is described. However, processors 25, 26, 26B, and 26C may be provided in control boxes 10 and 10A.

In the first to sixth embodiments, an example, in which sound source detection devices 30, 30A, 30B, and 30C include omnidirectional camera CA, is described. However, sound source detection device 30 and omnidirectional camera CA may be separately formed. In addition, omnidirectional camera CA may be omitted.

In the first to sixth embodiments, an example, in which microphone array MA and processor 26, which processes the sound signal, in sound source detection device 30 are provided in the same housing, is described. However, microphone array MA and processor 26 may be provided in separate housings. For example, microphone array MA may be included in sound source detection device 30 and processor 26 may be provided in control box 10 or 10A.

In the first to sixth embodiments, an example, in which sound source detection device 30 is attached such that the upper part of the vertical direction becomes the sound collection surface and the imaging surface, is described. However, sound source detection device 30 may be attached in another direction. For example, sound source detection device 30 may be attached such that a lateral part which is perpendicular to the vertical direction becomes the sound collection surface and the imaging surface.

In the fifth embodiment, an example, in which the detection result of moving body dn and the notification of the invasion performed by moving body dn are provided with respect to monitoring device 90, is described. However, the notification may be provided with respect to monitor 50, similar to the first to fourth embodiments.

In the fifth embodiment, an example, in which the number of sound source detection devices 30 is two, is described. However, the number of sound source detection devices 30 may be determined in accordance with, for example, the warning level of an area in which sound source detection device 30 is installed. For example, the number of installed sound source detection devices 30 may increase as the warning level is high, and the number of installed sound source detection devices 30 may decrease as the warning level is low.

In the fifth embodiment, an example, in which monitoring device 90 is provided separately from object detection system 5E, is described. However, monitoring device 90 may be included in object detection system 5E.

In the first to sixth embodiments, the processor may be formed physically in any way. In addition, in a case where a programmable processor is used, it is possible to change processing content by changing a program, and thus it is possible to increase the degree of freedom for design of the processor. One semiconductor chip may form the processor or a plurality of semiconductor chips may physically form the processor. In a case where the plurality of semiconductor chips form the processor, respective controls performed in the first to sixth embodiments may be realized by separate semiconductor chips. In this case, it is possible to consider that the plurality of semiconductor chips form one processor. In addition, the processor may include a member (condenser or the like) which has a function that is different from the semiconductor chip. In addition, one semiconductor chip may be formed such that a function included in the processor and other functions are realized.

### INDUSTRIAL APPLICABILITY

The present disclosure is useful for an object detection device, an object detection system, an object detection method, and the like in which it is possible to improve object detection accuracy.

### REFERENCE MARKS IN THE DRAWINGS

10A, 10B DIRECTIVITY CONTROL SYSTEM

5, 5A, 5B, 5C, 5D, 5E OBJECT DETECTION SYSTEM

8 MONITORING AREA

10, 10A CONTROL BOX

21, 72 IMAGE SENSOR

22, 73 IMAGING SIGNAL PROCESSOR

23, 74 CAMERA CONTROLLER

25, 26, 26B, 26C, 45, 68, 77 PROCESSOR

30, 30A, 30B, 30C SOUND SOURCE DETECTION DEVICE

31 A/D CONVERTER

32 BUFFER MEMORY

32A, 46 MEMORY

33 DIRECTIVITY PROCESSOR

34 FREQUENCY ANALYZER

35 TARGET DETECTOR

36 DETECTION RESULT DETERMINATION UNIT

37 SCAN CONTROLLER

38 DETECTION DIRECTION CONTROLLER

39 SOUND SOURCE DIRECTION DETECTOR

40 SYSTEM CONTROLLER

50 MONITOR

55 WIRELESS COMMUNICATOR

60 DISTANCE MEASUREMENT DEVICE

61 ULTRASONIC SENSOR

62 ULTRASONIC SPEAKER

63 RECEPTION CIRCUIT

64 PULSE TRANSMITTING CIRCUIT

65 PT UNIT

66 DISTANCE MEASURER

67 DISTANCE MEASUREMENT CONTROLLER

70 PTZ CAMERA

71 ZOOM LENS

72 IMAGE SENSOR

73 IMAGING SIGNAL PROCESSOR

74 CAMERA CONTROLLER

75 PTZ CONTROL UNIT

90 MONITORING DEVICE

91 DISPLAY

92 WIRELESS COMMUNICATION DEVICE

BF1, dr1 DIRECTIONAL RANGE

BF2, dr2 DIRECTIVITY DIRECTION

B1 BUILDING

CA OMNIDIRECTIONAL CAMERA

dn MOVING BODY

GZ1 OMNIDIRECTIONAL IMAGE

GZ2 PTZ IMAGE

GZL ENLARGEMENT IMAGE

Lg LENGTH

MA, MA1, MA2 MICROPHONE ARRAY

M1 to M8 MICROPHONE

sp1 SOUND SOURCE DIRECTION IMAGE

Wd WIDTH

1. An object detection device comprising:
a microphone array that includes a plurality of non-directional microphones; and
a processor that processes first sound data obtained by collecting sounds by the microphone array,
wherein the processor
generates a plurality of items of second sound data having directivity in an arbitrary direction by sequentially changing a directivity direction based on the first sound data,
analyzes a sound pressure level and a frequency component of the second sound data, and
determines that an object exists in a first direction in a case where a sound pressure level of a specific frequency, which is included in the frequency component of the second sound data having directivity in the first direction of the arbitrary direction, is equal to or larger than a first prescribed value.

2. The object detection device of claim 1,
wherein the processor
generates a plurality of items of third sound data having directivity in an arbitrary direction range by sequentially changing a directivity direction range based on the first sound data,
generates the plurality of items of second sound data having directivity in the arbitrary direction included in a first direction range by sequentially changing the directivity direction based on the first sound data in a case where the sound pressure level of the specific frequency, which is included in a frequency component of the third sound data having directivity in the first direction range of the arbitrary direction range, is equal to or larger than a second prescribed value, and
determines that the object exists in the first direction in a case where the sound pressure level of the specific frequency, which is included in the frequency component of the second sound data having directivity in the first direction of the arbitrary direction, is equal to or larger than the first prescribed value.

3. The object detection device of claim 1,
wherein the processor
determines that the object exists in the first direction range of the arbitrary direction range according to a cross-power spectrum phase analysis method,
generates the plurality of items of second sound data having directivity in the arbitrary direction included in the first direction range, and
determines that the object exists in the first direction in a case where the sound pressure level of the specific frequency, which is included in the frequency component of the second sound data having directivity in the first direction of the arbitrary direction, is equal to or larger than the first prescribed value.

4. The object detection device of claims 1,
wherein the processor determines that the object exists in the first direction in a case where the sound pressure level and the frequency component of the second sound data having directivity in the first direction approximate to a prescribed pattern.

5. The object detection device of claims 1,
wherein the processor
detects an approach of the object based on change in time of the sound pressure level in the specific frequency, and
determines that the object exists in a prescribed area in a case where the approach of the object is detected and the sound pressure level of the specific frequency is equal to or larger than a third prescribed value which is larger than the first prescribed value.

6. An object detection system comprising:
an object detection device;
a first camera;
a control device; and
a monitor,
wherein the object detection device
collects sounds using a microphone array that includes a plurality of non-directional microphones,
generates a plurality of items of second sound data having directivity in an arbitrary direction by sequentially changing a directivity direction based on first sound data obtained by collecting sounds by the microphone array,
analyzes a sound pressure level and a frequency component of the second sound data,
determines that an object exists in a first direction in a case where a sound pressure level of a specific frequency, which is included in the frequency component of the second sound data having directivity in the first direction of the arbitrary direction, is equal to or larger than a first prescribed value, and
transmits a result of determination of existence of the object to the control device,
wherein the first camera images an image which has an omnidirectional angle of view, and
wherein the monitor superimposes positional information of the object, which is determined to exist in the first direction, on the image data, which is imaged by the first camera, and displays the superimposed image under control of the control device.

7. The object detection system of claim 6, further comprising:
a distance measurement device that includes a first actuator which is capable of changing a distance measurement direction,
wherein the distance measurement device
changes the distance measurement direction in a case where the first actuator is driven, and measures a distance up to the object, which exists in the first direction, from the microphone array, and
transmits a result of measurement of the distance to the control device, and
wherein the control device determines that the object exists in a prescribed area in a case where the measured distance is included within a prescribed distance.

8. The object detection system of claim 7,
wherein the object detection device further includes
a first object detection device that detects the object using a first microphone array; and
a second object detection device that detects the object using a second microphone array, and
wherein the control device
derives the distance up to the object from the first object detection device or the second object detection device based on a second direction in which the object detected by the first object detection device exists, a third direction in which the object detected by the second object detection device exists, and a distance between the first object detection device and the second object detection device, and
determines that the object exists in the prescribed area in a case where the derived distance is included within the prescribed distance.

9. The object detection system of claim 7, further comprising:
a second camera that includes a second actuator which is capable of changing an imaging direction,
wherein the second camera changes the imaging direction in a case where the second actuator is driven, and images the object which exists in the first direction, and
wherein the monitor displays an image, which is imaged by the second camera, under control of the control device.

10. The object detection system of claim 9,
wherein the control device
estimates a size of the object based on a size of an area of the object in the image, which is imaged by the second camera, and the distance up to the object from the microphone array, and
determines that the object is a detection target in a case where the size of the object is included in a prescribed size range.

11. An object detection method for detecting an object using a microphone array that includes a plurality of non-directional microphones, the method comprising:
generating a plurality of items of second sound data having directivity in an arbitrary direction by sequentially changing a directivity direction based on first sound data obtained by collecting sounds by the microphone array;
analyzing a sound pressure level and a frequency component of the second sound data; and
determining that an object exists in a first direction in a case where a sound pressure level of a specific frequency, which is included in the frequency component of the second sound data having directivity in the first direction of the arbitrary direction, is equal to or larger than a prescribed value.
